(19) United States
(12) Patent Application Publication
(10) Pub. No.: US 2024/0341003 A1
(43) Pub. Date: Oct. 10, 2024

(54) METHOD AND APPARATUS FOR PROVIDING L1/L2 SIGNALING FOR ACTIVATION/DEACTIVATION OF CELL DTX/DRX IN WIRELESS COMMUNICATION SYSTEM

(71) Applicant: Samsung Electronics Co., Ltd., Suwon-si (KR)

(72) Inventors: Sangkyu BAEK, Suwon-si (KR); Anil AGIWAL, Mountain View, CA (US); Byounghoon JUNG, Suwon-si (KR)

(21) Appl. No.: 18/623,348

(22) Filed: Apr. 1, 2024

Related U.S. Application Data
(60) Provisional application No. 63/456,989, filed on Apr. 4, 2023.

(51) Int. Cl. H04W 76/28

(52) U.S. Cl. CPC H04W 76/28

(57) ABSTRACT

The disclosure relates to a fifth generation (5G) or sixth generation (6G) communication system for supporting a higher data transmission rate. The disclosure provides a method and an apparatus for activating/deactivating a cell discontinuous transmission (DTX) operation and a cell discontinuous reception (DRX) operation. A method performed by a base station of a wireless communication system is provided. The method includes generating a cell DTX/DRX operation message including at least one field indicating an operation regarding at least one of a cell DTX operation and a cell DRX operation regarding each of at least one cell, transmitting, to a user equipment (UE), the generated cell DTX/DRX operation message, and performing communication with the UE in the at least one cell according to a cell DTX/DRX operation based on the transmitted cell DTX/DRX operation message.

### CROSS-REFERENCE TO RELATED APPLICATION(S)

This application is based on and claims priority under 35 U.S.C. § 119(e) of a U.S. Provisional application Ser. No. 63/456,989, filed on Apr. 4, 2023, in the U.S. Patent and Trademark Office, the disclosure of which is incorporated by reference herein in its entirety.

### BACKGROUND

### 1. Field

The disclosure relates to operations of a user equipment (UE) and a base station in a wireless communication system. More particularly, the disclosure relates to a method and an apparatus for activation/deactivation (A/D) of cell discontinuous transmission (DTX)/discontinuous reception (DRX).

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mm Wave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing a service in a wireless communication system.

Additional aspects will be set forth in part in the description which follows and, in part, will be apparent from the description, or may be learned by practice of the presented embodiments.

In accordance with an aspect of the disclosure, a method performed by a base station of a wireless communication system is provided. The method includes generating a cell discontinuous transmission (DTX)/discontinuous reception (DRX) operation message including at least one field indicating an operation regarding at least one of a cell DTX operation and a cell DRX operation regarding each of at least one cell, transmitting, to a user equipment (UE), the generated cell DTX/DRX operation message, and performing communication with the UE in the at least one cell according to a cell DTX/DRX operation based on the transmitted cell DTX/DRX operation message.

The at least one field includes at least one bit indicating activation or deactivation of a cell DTX operation regarding each of the at least one cell, and at least one bit indicating activation or deactivation of a cell DRX operation regarding each of the at least one cell.

The at least one field includes a bit indicating activation and deactivation of the cell DTX operation and the cell DRX operation regarding each of the at least one cell, or one of the cell DTX operation or the cell DRX operation.

The method further includes transmitting a radio resource control (RRC) message to the UE, the RRC message including at least one of configuration information regarding the cell DTX operation and configuration information regarding the cell DRX operation.

The cell DTX/DRX operation message is a medium access control (MAC) control element (CE) or downlink control information (DCI).

The cell DTX operation is performed based on multiple pieces of DTX configuration information, the cell DRX operation is performed based on multiple pieces of DRX configuration information, and the at least one field includes a bit indicating at least one of the multiple pieces of DTX configuration information and the multiple pieces of DRX configuration information.

In accordance with another aspect of the disclosure, a method performed by a UE of a wireless communication system is provided. The method includes receiving, from a base station, a cell DTX/DRX operation message corresponding to at least one cell, the cell DTX/DRX operation message including at least one field indicating at least one of a cell DTX operation and a cell DRX operation regarding each of the at least one cell, and performing communication with the base station in the at least one cell according to a cell DTX/DRX operation based on the received cell DTX/DRX operation message.

The at least one field includes at least one bit indicating activation or deactivation of a cell DTX operation regarding each of the at least one cell, and at least one bit indicating activation or deactivation of a cell DRX operation regarding each of the at least one cell.

The at least one field includes a bit indicating activation and deactivation of the cell DTX operation and the cell DRX operation regarding each of the at least one cell, or one of the cell DTX operation or the cell DRX operation.

The cell DTX operation is performed based on multiple pieces of DTX configuration information, the cell DRX operation is performed based on multiple pieces of DRX configuration information, and the at least one field includes a bit indicating at least one of the multiple pieces of DTX configuration information and the multiple pieces of DRX configuration information.

In accordance with another aspect of the disclosure, a base station of a wireless communication system is provided. The base station includes a transceiver, memory storing one or more computer programs, and one or more processors communicatively coupled to the transceiver and the memory, wherein the one or more computer programs include computer-executable instructions that, when executed by the one or more processors, cause the base station to generate a cell DTX/DRX operation message including at least one field indicating an operation regarding at least one of a cell DTX operation and a cell DRX operation regarding each of at least one cell, transmit, to a UE, the generated cell DTX/DRX operation message, and perform communication with the UE in the at least one cell according to a cell DTX/DRX operation based on the transmitted cell DTX/DRX operation message.

The at least one field includes at least one bit indicating activation or deactivation of a cell DTX operation regarding each of the at least one cell, and at least one bit indicating activation or deactivation of a cell DRX operation regarding each of the at least one cell.

The at least one field includes a bit indicating activation and deactivation of the cell DTX operation and the cell DRX operation regarding each of the at least one cell, or one of the cell DTX operation or the cell DRX operation.

The at least one processor transmits a radio resource control (RRC) message to the UE, the RRC message including at least one of configuration information regarding the cell DTX operation and configuration information regarding the cell DRX operation.

The cell DTX/DRX operation message is a medium access control (MAC) control element (CE) or downlink control information (DCI).

The cell DTX operation is performed based on multiple pieces of DTX configuration information, the cell DRX operation is performed based on multiple pieces of DRX configuration information, and the at least one field includes a bit indicating at least one of the multiple pieces of DTX configuration information and the multiple pieces of DRX configuration information.

In accordance with another aspect of the disclosure, a UE of a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to receive, from a base station, a cell DTX/DRX operation message corresponding to at least one cell, the cell DTX/DRX operation message including at least one field indicating at least one of a cell DTX operation and a cell DRX operation regarding each of the at least one cell, and perform communication with the base station in the at least one cell according to a cell DTX/DRX operation based on the received cell DTX/DRX operation message.

The at least one field includes at least one bit indicating activation or deactivation of a cell DTX operation regarding each of the at least one cell, and at least one bit indicating activation or deactivation of a cell DRX operation regarding each of the at least one cell.

The at least one field includes a bit indicating activation and deactivation of the cell DTX operation and the cell DRX operation regarding each of the at least one cell, or one of the cell DTX operation or the cell DRX operation.

The cell DTX operation is performed based on multiple pieces of DTX configuration information, the cell DRX operation is performed based on multiple pieces of DRX configuration information, and the at least one field includes a bit indicating at least one of the multiple pieces of DTX configuration information and the multiple pieces of DRX configuration information.

In accordance with another aspect of the disclosure, one or more non-transitory computer-readable storage media storing computer-executable instructions that, when executed by one or more processors of a base station, cause the base station to perform operations are provided. The operations include generating a cell discontinuous transmission (DTX)/discontinuous reception (DRX) operation message comprising at least one field indicating an operation regarding at least one of a cell DTX operation and a cell DRX operation regarding each of at least one cell, transmitting, to a user equipment (UE), the generated cell DTX/DRX operation message, and performing communication with the UE in the at least one cell according to a cell DTX/DRX operation based on the transmitted cell DTX/DRX operation message.

The disclosure advantageously provides an apparatus and a method capable of effectively providing a service in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network power consumption reduction scheme in a wireless communication system according to an embodiment of the disclosure;

FIG. 2 illustrates a cell discontinuous transmission (DTX) or cell discontinuous reception (DRX) operation scheme according to an embodiment of the disclosure;

FIG. 3 illustrates a cell DTX or cell DRX operation scheme according to an embodiment of the disclosure;

FIG. 4 illustrates a format of a message indicating activation or deactivation of cell DTX or cell DRX, and an operation scheme based thereon according to an embodiment of the disclosure;

FIG. 5 illustrates a format of a message indicating activation or deactivation of cell DTX or cell DRX, and an operation scheme based thereon according to an embodiment of the disclosure;

FIG. 6 illustrates a format of a message indicating activation or deactivation of cell DTX or cell DRX, and an operation scheme based thereon according to an embodiment of the disclosure;

FIG. 7 illustrates a format of a message indicating activation or deactivation of cell DTX or cell DRX, and an operation scheme based thereon according to an embodiment of the disclosure;

FIG. 8 illustrates a format of a message indicating activation or deactivation of cell DTX or cell DRX, and an operation scheme based thereon according to an embodiment of the disclosure;

FIG. 9 illustrates a format of a message indicating activation or deactivation of cell DTX or cell DRX, and an operation scheme based thereon according to an embodiment of the disclosure;

FIG. 10 illustrates a format of a message indicating activation or deactivation of cell DTX or cell DRX, and an operation scheme based thereon according to an embodiment of the disclosure;

FIG. 11 illustrates a format of a message indicating activation or deactivation of cell DTX or cell DRX, and an operation scheme based thereon according to an embodiment of the disclosure;

FIG. 12 illustrates a format of a message indicating activation or deactivation of cell DTX or cell DRX, and an operation scheme based thereon according to an embodiment of the disclosure;

FIG. 13 illustrates a format of a message indicating activation or deactivation of cell DTX or cell DRX, and an operation scheme based thereon according to an embodiment of the disclosure;

FIG. 14 illustrates a format of a message indicating activation or deactivation of cell DTX or cell DRX, and an operation scheme based thereon according to an embodiment of the disclosure;

FIG. 15 illustrates a format of a message indicating activation or deactivation of cell DTX or cell DRX, and an operation scheme based thereon according to an embodiment of the disclosure;

FIG. 16 illustrates a format of a message indicating activation or deactivation of cell DTX or cell DRX, and an operation scheme based thereon according to an embodiment of the disclosure;

FIG. 17 illustrates a format of a message indicating activation or deactivation of cell DTX or cell DRX, and an operation scheme based thereon according to an embodiment of the disclosure;

FIG. 18 illustrates a format of a message indicating activation or deactivation of cell DTX or cell DRX, and an operation scheme based thereon according to an embodiment of the disclosure;

FIG. 19 illustrates a format of a message indicating activation or deactivation of cell DTX or cell DRX, and an operation scheme based thereon according to an embodiment of the disclosure;

FIG. 20 illustrates a format of a message indicating activation or deactivation of cell DTX or cell DRX, and an operation scheme based thereon according to an embodiment of the disclosure;

FIG. 21 illustrates a format of a message indicating activation or deactivation of cell DTX or cell DRX, and an operation scheme based thereon according to an embodiment of the disclosure;

FIG. 22 illustrates a format of a message indicating activation or deactivation of cell DTX or cell DRX, and an operation scheme based thereon according to an embodiment of the disclosure;

FIG. 23 illustrates a format of a message indicating activation or deactivation of cell DTX or cell DRX, and an operation scheme based thereon according to an embodiment of the disclosure;

FIG. 24 illustrates a structure of a base station according to an embodiment of the disclosure; and

FIG. 25 illustrates a structure of a user equipment (UE) according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, the terms “physical channel” and “signal” may be interchangeably used with the term “data” or “control signal”. For example, the term “physical downlink shared channel (PDSCH)” refers to a physical channel over which data is transmitted, but may also be used to refer to the “data”. For example, in the disclosure, the expression “transmit ting a physical channel” may be construed as having the same meaning as the expression “transmitting data or a signal over a physical channel”.

In the following description of the disclosure, higher signaling refers to a signal transfer scheme from a base station to a terminal via a downlink data channel of a physical layer, or from a terminal to a base station via an uplink data channel of a physical layer. The higher signaling may also be understood as radio resource control (RRC) signaling or a media access control (MAC) control element (CE).

In the following description of the disclosure, terms and names defined in the 3^{rd} generation partnership project new radio (3GPP NR) or 3^{rd} generation partnership project long term evolution (3GPP LTE) standards will be used for the sake of descriptive convenience. However, the disclosure is not limited by these terms and names, and may be applied in the same way to systems that conform other standards. In the disclosure, the term “g NB” may be interchangeably used with the term “e NB” for the sake of descriptive convenience. For example, a base station described as “eNode B (eNB)” may indicate “gNode B (gNB)”. In addition, the term “terminal” may refer to mobile phones, machine type communication (MTC) devices, narrowband internet of things (NB-IoT) devices, sensors, and other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited to the above examples.

More particularly, the disclosure may be applied to 3GPP NR (5^{th} generation wireless communication standard). In addition, the disclosure may be applied to intelligent services (e.g., smart homes, smart buildings, smart cities, smart cars or connected cars, healthcare, digital education, retail business, security and safety-related services, or the like) based on 5G communication technology and IoT-related technology. In the disclosure, the term “eNB” may be interchangeably used with the term “gNB” for the sake of descriptive convenience. For example, a base station described as “eNB” may indicate “gNB”. In addition, the term “terminal” may refer to mobile phones, NB-IoT devices, sensors, and other wireless communication devices.

A wireless communication system is advancing to a broadband wireless communication system for providing high-speed and high-quality packet data services using communication standards, such as high-speed packet access (HSPA) of 3GPP, long-term evolution (LTE) or evolved universal terrestrial radio access (E-UTRA), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (or eNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a communication system subsequent to LTE, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment of the disclosure, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of things. Since the Internet of things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and may also may require a design for assigning a large number of resources in a frequency band in order to secure reliability of a communication link.

The above three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are only examples of different types of services, and service types to which the disclosure is applicable are not limited to the above-described examples.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

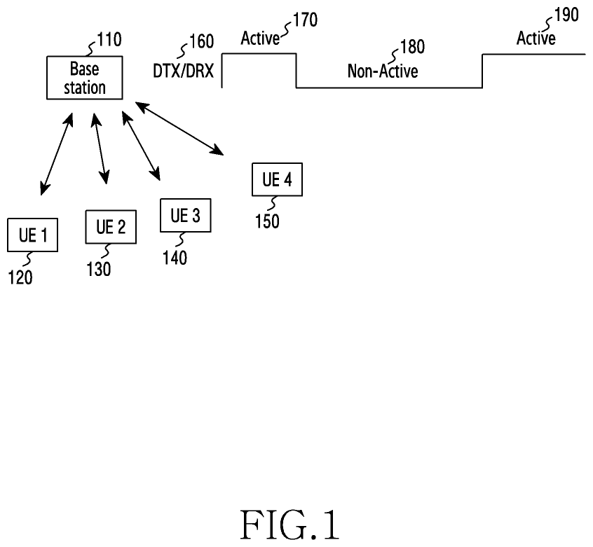

FIG. 1 illustrates a network power consumption reduction scheme in a wireless communication system according to an embodiment of the disclosure.

Referring to FIG. 1, in the wireless communication system, a base station 110 provides a communication service to multiple UEs 120, 130, 140, and 150. Various UEs may be positioned in the coverage of one base station, and the base station needs to provide a communication service to multiple UEs. Therefore, the base station has a larger amount of power consumption than UEs. Furthermore, in the case of 5G wireless communication which requires high-speed transmission, a larger bandwidth, a higher level of transmission signal intensity, and a higher level of reception sensitivity are necessary for the high-speed transmission, thereby resulting in a large amount of power consumption. Since one mobile communication operator manages tens of thousands of base stations at least (hundreds of thousands of base stations in some cases), the large amount of power consumed by the communication network, including base stations, may increase the costs of management, maintenance, and repair of the mobile communication network. Therefore, a method for reducing the power consumed by the communication network may be necessary. The power consumed by the communication network may be reduced if base stations temporarily power off transceivers. Base stations may be able to power off transceivers only when no communication is performed with UEs to which the base stations need to provide a communication service.

The embodiment in FIG. 1 illustrates a cell discontinuous transmission (DTX)/discontinuous reception (DRX) scheme in which the base station periodically powers off the transceiver entirely or partially. Cell DTX indicates whether the transmitter (downlink) of the base station is powered off, and cell DRX indicates whether the receiver (uplink) of the base station is powered off. The embodiment in FIG. 1 illustrates a DTX or DRX state 160. If the DTX/DRX state of the base station is an active state 170 or 190, the base station performs a procedure necessary for transmission/reception with a UE while the transceiver remains powered on. For example, the base station may indicate resource allocation information in a physical downlink control channel (PDCCH) to allocate a downlink resource to the UE, and may perform data transmission in a physical downlink shared channel (PDSCH). However, if the base station has no or a small amount of data to transmit/receive with the UE, the base station may switch the DTX/DRX state to a non-active state 180 and may power off the transceiver. If the UE is aware of the DTX/DRX state of the base station, the UE may also power off the UE's transceiver, thereby reducing power consumption, and may not perform an unnecessary communication procedure. A transition in the DTX/DRX state of the base station may occur for a predetermined period of time, or may be changed by separate control information. The embodiment in FIG. 1 illustrates periodically repeated DTX/DRX.

The base station may entirely power off the transceiver in the non-active state 180, but a specific transmission/reception function of the base station may be deactivated in an embodiment such that power consumption is reduced to some extent. For example, transmission of downlink semi-persistent scheduling (SPS), which is periodically transmitted from the base station to the UE in the non-active state of cell DTX, may be deactivated. In some embodiments of the disclosure, transmission of an uplink configured grant (CG), which is transmitted from the UE to the base station during the cell DTX, may be deactivated such that the base station does not receive the CG in the DRX non-active state. As such, the base station may notify the UE whether a specific transmission/reception function will be deactivated, and the UE may not perform an operation corresponding to the function deactivated by the base station such that the UE can also reduce unnecessary power consumption, and erroneous operations of the UE can be prevented. Cell DTX and cell DRX may be configured separately, or configured simultaneously in one cell. In some embodiments of the disclosure, multiple cell DTXs and cell DRXs may be configured in one cell, and a maximum of one DTX and a maximum of one DRX may be activated at one timepoint. The base station may transmit a layer 1 (L1) message of the physical layer or a layer 2 (L2) message of the medium access control (MAC) layer to the UE to indicate which cell DTX and cell DRX are to be activated/deactivated. The L1 message may have a downlink control information (DCI) format in the PDCCH physical channel. The L2 message may have a MAC control element (CE) format of the MAC layer.

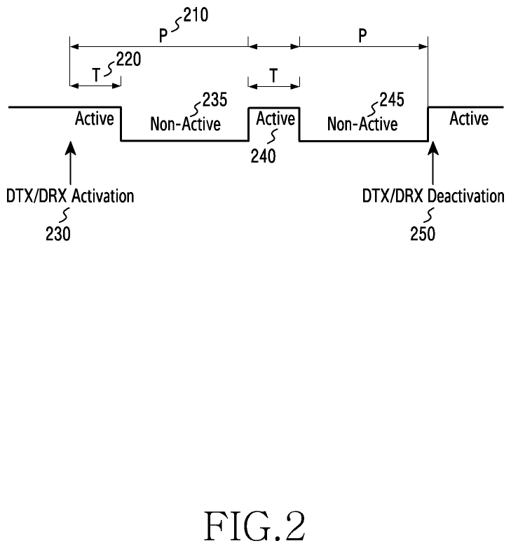

FIG. 2 illustrates a cell DTX or cell DRX operation scheme according to an embodiment of the disclosure.

Referring to FIG. 2, during cell DTX/DRX defined to reduce power consumed by the base station, the UE may operate so as to periodically transition between an active state and a non-active state. In an embodiment of the disclosure, the length of the active state may increase, and the length of the non-active state may decrease, depending on the amount of traffic to be processed by the base station. Such cell DTX or cell DRX may be configured for the UE by the base station through an RRC message. The embodiment in FIG. 2 illustrates a method wherein the base station having cell DTX or cell DRX configured therefor transmits a message 230 or 250 to the UE to indicate whether cell DTX or cell DRX is to be activated. The UE may identify a message 230 or 250 from the base station in the active state of cell DTX/DRX and may activate a cell DTX/DRX configuration in which the UE periodically repeats the active state. It is assumed in the embodiment in FIG. 2 that the period at which the UE starts an on-duration to periodically start an active state is P 210, and the on-during time during which the UE transitions to the active state is T 520. The value of P 210 and T 220 may be transferred from the base station through an RRC message and configured accordingly. Furthermore, an offset value indicating the starting point of on-duration T 220 and period P 210 may also be configured. Upon receiving a message indicating activation of cell DTX or cell DRX, the UE may then activate a cell DTX or cell DRX operation during time T 220 at every period P 210. The UE may then transition to a non-active state 235 at the ending point of time T 220. Thereafter, the UE may transition to an active state 240 during time T 220 at the starting point of the next period P 210 and may perform transmission/reception related to the base station. It is assumed in the embodiment in FIG. 2 that, in the active state 240, the UE does not receive a separate message. Thereafter, the UE may again transition to a non-active state 245 after time T 220. The UE may then identify a message in an active state during time T 220 at the starting point of period P 210. It is assumed in the embodiment in FIG. 2 that, in this regard, the UE is instructed by the base station to deactivate cell DTX/DRX and to always maintain the active state. Thereafter, the UE may maintain the active state until another cell DTX or cell DRX is activated. In an embodiment of the disclosure, cell DTX/DRX information, such as the value of P 210 and T 220 may be configured for the UE by the base station through an RRC message, but the message instructing the UE to activate or deactivate cell DTX/DRX may be configured dynamically through a MAC CE or DCI.

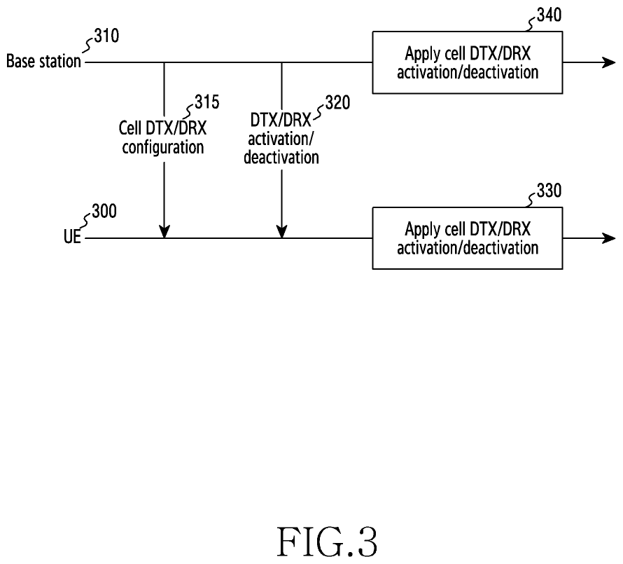

FIG. 3 illustrates a cell DTX or cell DRX operation scheme according to an embodiment of the disclosure.

Referring to FIG. 3, a base station 310 may configure cell DTX so as to periodically block the transmission function of the base station or cell DRX so as to periodically block the reception function thereof, for each cell, in order to reduce power consumed by the base station. When the base station 310 configures cell DTX or cell DRX and performs a corresponding operation, a UE 300 may perform an unnecessary transmission/reception operation without knowing the non-active state of the base station, thereby degrading the communication performance. In order to prevent this, the base station may transmit cell DTX or cell DRX (or both) configuration information to the UE to be applied in each cell. Cell DTX or cell DRX configuration information may configure each DTX or DRX or simultaneously configure DTX and DRX. The cell DTX or cell DRX configuration information may include at least one of a period P, an on-duration length T, and an offset value to start the period and on-duration. In an embodiment of the disclosure, multiple cell DTXs and multiple cell DRXs may be configured for one cell. In a carrier aggregation state, multiple cells configured for the UE may have different cell DTXs and cell DRXs configured therefor. However, a maximum of one cell DTX and a maximum of one cell DRX are to be activated at one timepoint in one cell. To this end, the message in operation 315 may indicate which cell DTX or cell DRX is to be activated. The message in operation 315 may be an RRC reconfiguration message. Thereafter, if the base station wants to activate or deactivate a specific cell DTX or cell DRX, the base station may transmit a cell DTX/DRX activation/deactivation message to the UE, thereby indicating activation/deactivation of cell DTX or cell DRX. The message in operation 320 may be transmitted from the base station to the UE as a layer 1 (L1) message of the physical layer or a layer 2 (L2) message of the medium access control (MAC) layer. The L1 message may have a downlink control information (DCI) format in the PDCCH physical channel. The L2 message may have a MAC control element (CE) format of the MAC layer. Thereafter, the UE and the base station may apply activation or deactivation of cell DTX or cell DRX according to information in the message transmitted in operations 320, 330, and 340. The message may include a starting time to indicate the timepoint at which corresponding cell DTX or cell DRX is to be activated, without instantly applying cell DTX and cell DRX.

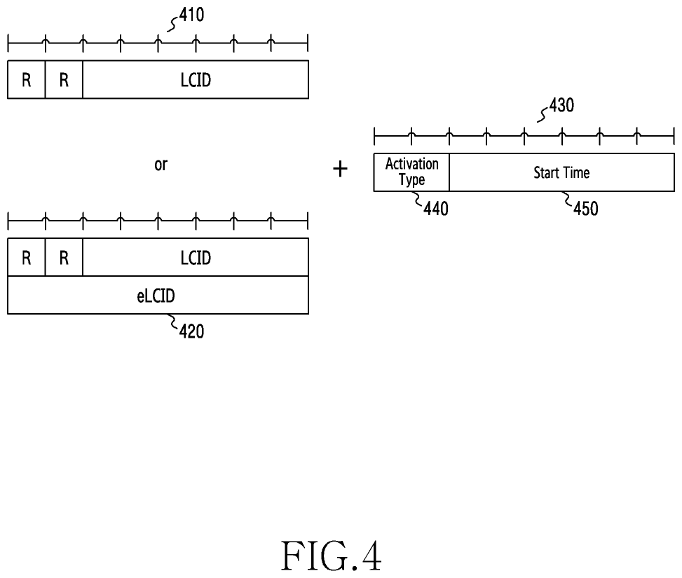

FIG. 4 illustrates a format of a message indicating activation or deactivation of cell DTX or cell DRX, and an operation scheme based thereon according to an embodiment of the disclosure.

Referring to FIG. 4, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 4 in a medium access control (MAC) control element (CE) format, the message may be transmitted in a downlink control information (DCI) format, and the information included therein and the UE operation may be identical. A MAC sub-header may be included such that a MAC CE is transmitted, and the MAC sub-header may include a logical channel identity (LCID) field or extended logical channel identity (eLCID) field to specify the MCE CE. One value in the LCID field may indicate that the MAC CE is a message indicating activation or deactivation of cell DTX or cell DRX 410. However, in some embodiments of the disclosure, due to the insufficient number of available cases of the LCID field, one value in the eLCID field may indicate that the MAC CE is a message indicating activation or deactivation of cell DTX or cell DRX 420. The MAC CE 430 may include at least one of an activation type field 440 indicating whether the UE is actually instructed to activate or deactivate cell DTX or cell DRX, and a start time field 450 indicating the timepoint of actual application of activation or deactivation of cell DTX or cell DRX, activation or deactivation of which has been indicated.

The activation type field 440 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX, the UE may ignore the indication through the activation type field 440 with regard to a field not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 450 to indicate at which timepoint the message is to be applied.

The start time field 450 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 450, the UE may apply a value included in the start time field 450 with reference to the closest timepoint among future timepoints indicated by the start time. Obviously, the start time field 450 may have a value indicating instant application of the message.

In an embodiment of the disclosure, the start time field 450 may indicate a timepoint at which corresponding cell DTX or cell DRX is to be activated or deactivated with reference to the period of DTX or DRX. For example, a value in the start time field 450 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 450 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 450 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

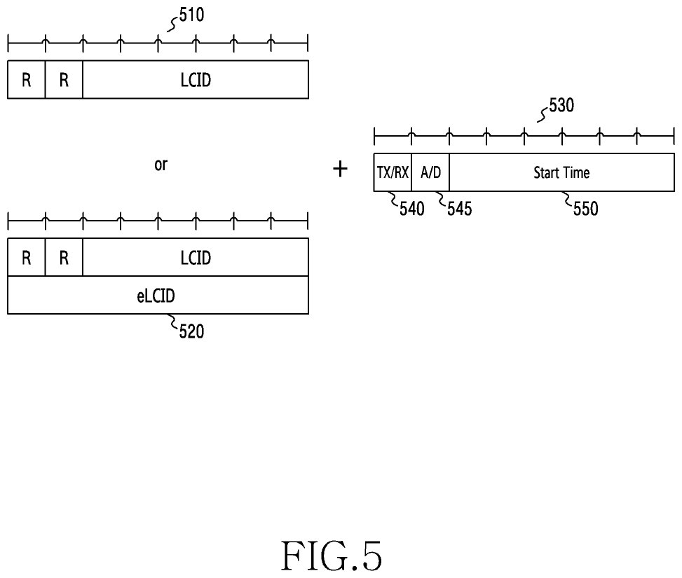

FIG. 5 illustrates a format of a message indicating activation or deactivation of cell DTX or cell DRX, and an operation scheme based thereon according to an embodiment of the disclosure.

Referring to FIG. 5, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 5 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 510. However, in some embodiments of the disclosure, due to the insufficient number of available cases of the LCID field, one value in the eLCID field may indicate that the MAC CE is a message indicating activation or deactivation of cell DTX or cell DRX 520. A MAC CE 530 may include at least one of a one-bit transmit (TX)/receive (RX) field 540 indicating whether the message indicates activation or deactivation regarding cell DTX or cell DRX, and one-bit A/D field 545 indicating activation or deactivation with regard to the cell DTX or cell DRX indicated in the TX/RX field. Furthermore, the MAC CE 530 may include at least one of a start time field 550 indicating the timepoint of actual application of activation or deactivation of cell DTX or cell DRX, activation or deactivation of which has been indicated.

The TX/RX field 540 may be made up of one bit and may include some of the following two types of information:
0: cell DTX (downlink)
1: cell DRX (uplink)

The above example is characterized in that one bit is used to indicate cell DTX or cell DRX, and detailed bit values may vary depending on the embodiment.

The A/D field 545 may be made up of one bit and may include some of the following two types of information:
0: deactivation
1: activation

The above example is characterized in that one bit is used to indicate activation or deactivation of cell DTX or cell DRX, and detailed bit values may vary depending on the embodiment.

If an activation or deactivation indication is received through the TX/RX field and the A/D field with regard to cell DTX or cell DRX not configured for the UE among cell DTX and cell DRX, the UE may ignore the indication through the TX/RX field 540 and the A/D field 545 with regard to the cell DTX or cell DRX not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 550 to indicate at which timepoint the message is to be applied.

The start time field 550 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 550, the UE may apply a value included in the start time field 550 with reference to the closest timepoint among future timepoints indicated by the start time. Obviously, the start time field 550 may have a value indicating instant application of the message.

In an embodiment of the disclosure, the start time field 550 may indicate a timepoint at which corresponding cell DTX or cell DRX is to be activated or deactivated with reference to the period of DTX or DRX. For example, a value in the start time field 550 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 550 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 550 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

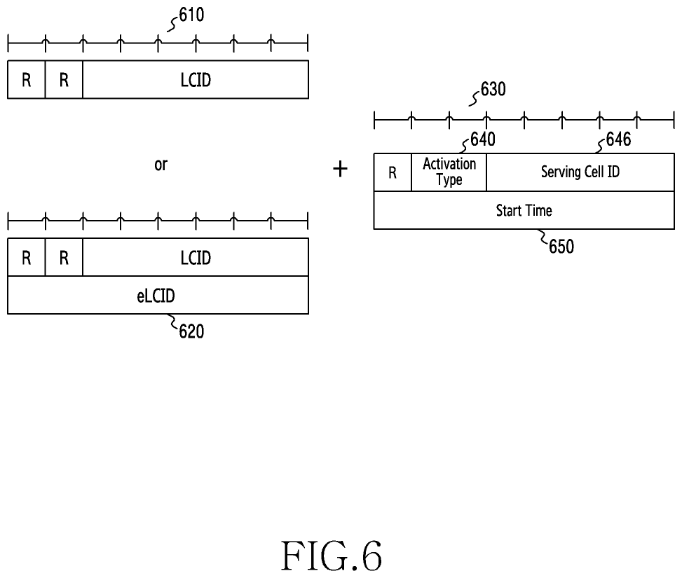

FIG. 6 illustrates a format of a message indicating activation or deactivation of cell DTX or cell DRX, and an operation scheme based thereon according to an embodiment of the disclosure.

Referring to FIG. 6, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 6 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 610. However, in some embodiments of the disclosure, due to the insufficient number of available cases of the LCID field, one value in the eLCID field may indicate that the MAC CE is a message indicating activation or deactivation of cell DTX or cell DRX 620. A MAC CE 630 may include at least one of an activation type field 640 indicating whether the UE is actually instructed to activate or deactivate cell DTX or cell DRX, a cell ID field 646 indicating the cell to which cell DTX or cell DRX indicated in the message indicating activation or deactivation of corresponding cell DTX or cell DRX is related, and a start time field 650 indicating the timepoint of actual application of activation or deactivation of cell DTX or cell DRX, activation or deactivation of which has been indicated.

The activation type field 640 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX, the UE may ignore the indication through the activation type field 640 with regard to a field not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

According to an embodiment of the disclosure, the cell ID field 646 may indicate the cell to which cell DTX or cell DRX indicated in the message indicating activation or deactivation of corresponding cell DTX or cell DRX is related. It is assumed in the embodiment in FIG. 6, for example, that a five-bit serving cell ID is configured for the UE to indicate the cell to which activation or deactivation of cell DTX or cell DRX is related, among cells configured for the UE. However, in other embodiments of the disclosure, other cell identifiers, such as a physical cell ID, may also be used.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 650 to indicate at which timepoint the message is to be applied.

The start time field 650 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 650, the UE may apply a value included in the start time field 650 with reference to the closest timepoint among future timepoints indicated by the start time. Obviously, the start time field 650 may have a value indicating instant application of the message.

In an embodiment of the disclosure, the start time field 650 may indicate a timepoint at which corresponding cell DTX or cell DRX is to be activated or deactivated with reference to the period of DTX or DRX. For example, a value in the start time field 650 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 650 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 650 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

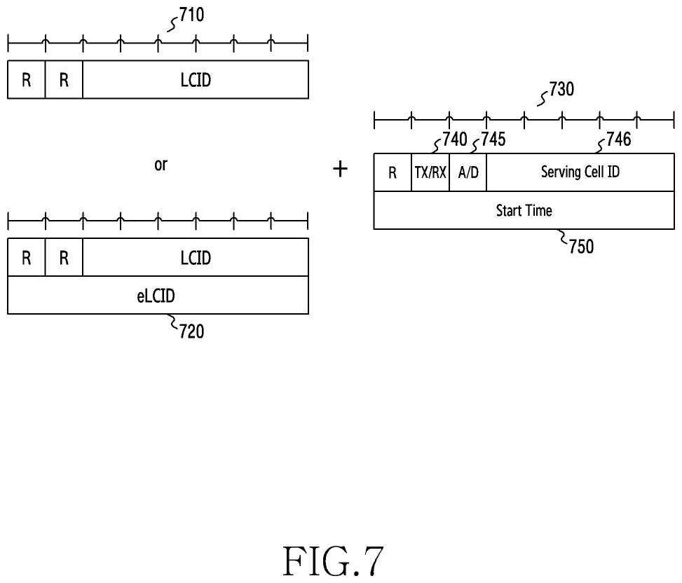

FIG. 7 illustrates a format of a message indicating activation or deactivation of cell DTX or cell DRX, and an operation scheme based thereon according to an embodiment of the disclosure.

Referring to FIG. 7, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 7 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 710. However, in some embodiments of the disclosure, due to the insufficient number of available cases of the LCID field, one value in the eLCID field may indicate that the MAC CE is a message indicating activation or deactivation of cell DTX or cell DRX 720. A MAC CE 730 may include at least one of a one-bit TX/RX field value 740 indicating whether the message indicates activation or deactivation regarding cell DTX or cell DRX, one-bit A/D field 745 indicating activation or deactivation with regard to the cell DTX or cell DRX indicated in the TX/RX field, and a cell ID field 746 indicating the cell to which cell DTX or cell DRX indicated in the message indicating activation or deactivation of corresponding cell DTX or cell DRX is related. Furthermore, the MAC CE 730 may include at least one of a start time field 750 indicating the timepoint of actual application of activation or deactivation of cell DTX or cell DRX, activation or deactivation of which has been indicated.

The TX/RX field 740 may be made up of one bit and may include some of the following two types of information:
0: cell DTX (downlink)
1: cell DRX (uplink)

The above example is characterized in that one bit is used to indicate cell DTX or cell DRX, and detailed bit values may vary depending on the embodiment.

The A/D field 745 may be made up of one bit and may include some of the following two types of information:
0: deactivation
1: activation

The above example is characterized in that one bit is used to indicate activation or deactivation of cell DTX or cell DRX, and detailed bit values may vary depending on the embodiment.

The cell ID field 746 may indicate the cell to which cell DTX or cell DRX indicated in the message indicating activation or deactivation of corresponding cell DTX or cell DRX is related. It is assumed in the embodiment in FIG. 7, for example, that a five-bit serving cell ID is configured for the UE to indicate the cell to which activation or deactivation of cell DTX or cell DRX is related, among cells configured for the UE. However, in other embodiments of the disclosure, other cell identifiers, such as a physical cell ID, may also be used.

If an activation or deactivation indication is received through the TX/RX field and the A/D field with regard to cell DTX or cell DRX not configured for the UE among cell DTX and cell DRX, the UE may ignore the indication through the TX/RX field 740 and the A/D field 745 with regard to the cell DTX or cell DRX not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 750 to indicate at which timepoint the message is to be applied.

The start time field 750 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 750, the UE may apply a value included in the start time field 750 with reference to the closest timepoint among future timepoints indicated by the start time. Obviously, the start time field 750 may have a value indicating instant application of the message.

In an embodiment of the disclosure, the start time field 750 may indicate a timepoint at which corresponding cell DTX or cell DRX is to be activated or deactivated with reference to the period of DTX or DRX. For example, a value in the start time field 750 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 750 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 750 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

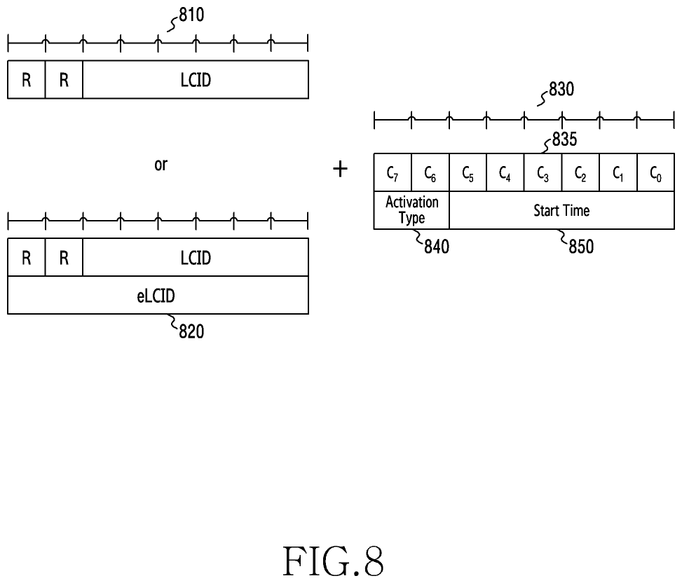

FIG. 8 illustrates a format of a message indicating activation or deactivation of cell DTX or cell DRX, and an operation scheme based thereon according to an embodiment of the disclosure.

Referring to FIG. 8, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 8 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 810. However, in some embodiments of the disclosure, due to the insufficient number of available cases of the LCID field, one value in the eLCID field may indicate that the MAC CE is a message indicating activation or deactivation of cell DTX or cell DRX 820. A MAC CE 830 may include at least one of a Ci bitmap 835 indicating the cell to which cell DTX or cell DRX indicated in a message indicating activation or deactivation of corresponding cell DTX or cell DRX is related, an activation type field 840 indicating whether the UE is actually instructed to activate or deactivate cell DTX or cell DRX, and a start time field 850 indicating the timepoint of actual application of activation or deactivation of cell DTX or cell DRX, activation or deactivation of which has been indicated.

The Ci bitmap 835 may indicate the cell to which cell DTX or cell DRX indicated in a message indicating activation or deactivation of corresponding cell DTX or cell DRX is related. Each bit in the Ci field may indicate activation or deactivation of cell DTX or cell DRX with regard to the cell indicated by index i. In an embodiment of the disclosure, index i may be a serving cell ID corresponding to a cell configured for the UE. In this case, Ci may indicate whether activation or deactivation of cell DTX or cell DRX is indicated with regard to the cell, the serving cell ID of which is i. For example, the Ci field value of 0 means that the activation and deactivation states of cell DTX and cell DRX are not changed with regard to the cell indicated by index i. If the Ci field value is 1, information regarding activation or deactivation of cell DTX or cell DRX related to the cell indicated by index i may be applied according to remaining field values of the message. The length of the Ci field may vary depending on the serving cell ID configured for the UE. In addition, in an embodiment of the disclosure, index i may be configured by an RRC message and used for the message. If there are two or more cells, and if the value indicated by the Ci field indicates activation or deactivation of cell DTX or cell DRX of the two or more cells, the message may apply activation or deactivation of cell DTX or cell DRX with regard to all of the two or more cells.

The activation type field 840 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX, the UE may ignore the indication through the activation type field 840 with regard to a field not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 850 to indicate at which timepoint the message is to be applied.

The start time field 850 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 850, the UE may apply a value included in the start time field 850 with reference to the closest timepoint among future timepoints indicated by the start time. Obviously, the start time field 850 may have a value indicating instant application of the message.

In an embodiment of the disclosure, the start time field 850 may indicate a timepoint at which corresponding cell DTX or cell DRX is to be activated or deactivated with reference to the period of DTX or DRX. For example, a value in the start time field 850 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 850 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 850 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

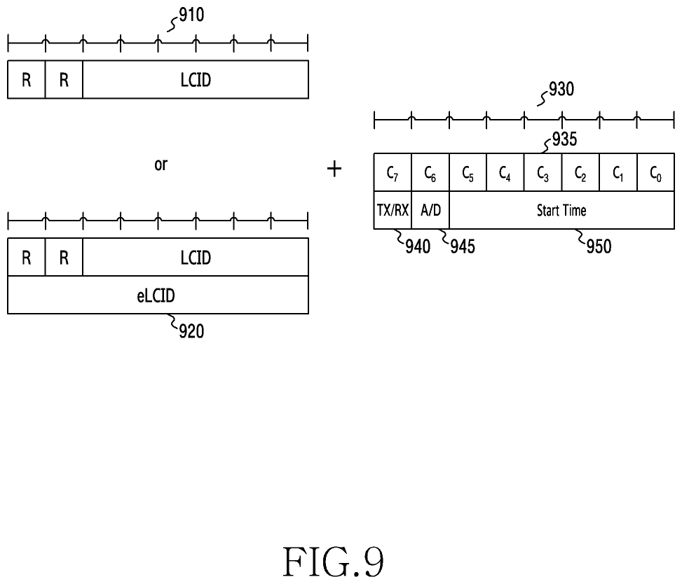

FIG. 9 illustrates a format of a message indicating activation or deactivation of cell DTX or cell DRX, and an operation scheme based thereon according to an embodiment of the disclosure.

Referring to FIG. 9, illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 9 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 910. However, in some embodiments of the disclosure, due to the insufficient number of available cases of the LCID field, one value in the eLCID field may indicate that the MAC CE is a message indicating activation or deactivation of cell DTX or cell DRX 920. A MAC CE 930 may include at least one of a Ci bitmap 935 indicating the cell to which cell DTX or cell DRX indicated in a message indicating activation or deactivation of corresponding cell DTX or cell DRX is related, a one-bit TX/RX field value indicating whether the message indicates activation or deactivation regarding cell DTX or cell DRX, and one-bit A/D field 945 indicating activation or deactivation with regard to the cell DTX or cell DRX indicated in the TX/RX field. Furthermore, the MAC CE 930 may include at least one of a start time field 950 indicating the timepoint of actual application of activation or deactivation of cell DTX or cell DRX, activation or deactivation of which has been indicated.

The Ci bitmap 935 may indicate the cell to which cell DTX or cell DRX indicated in a message indicating activation or deactivation of corresponding cell DTX or cell DRX is related. Each bit in the Ci field may indicate activation or deactivation of cell DTX or cell DRX with regard to the cell indicated by index i. In an embodiment of the disclosure, index i may be a serving cell ID corresponding to a cell configured for the UE. In this case, Ci may indicate whether activation or deactivation of cell DTX or cell DRX is indicated with regard to the cell, the serving cell ID of which is i. For example, the Ci field value of 0 means that the activation and deactivation states of cell DTX and cell DRX are not changed with regard to the cell indicated by index i. If the Ci field value is 1, information regarding activation or deactivation of cell DTX or cell DRX related to the cell indicated by index i may be applied according to remaining field values of the message. The length of the Ci field may vary depending on the serving cell ID configured for the UE. In addition, in an embodiment of the disclosure, index i may be configured by an RRC message and used for the message. If there are two or more cells, and if the value indicated by the Ci field indicates activation or deactivation of cell DTX or cell DRX of the two or more cells, the message may apply activation or deactivation of cell DTX or cell DRX with regard to all of the two or more cells.

A TX/RX field 940 may be made up of one bit and may include some of the following two types of information:
0: cell DTX (downlink)
1: cell DRX (uplink)

The above example is characterized in that one bit is used to indicate cell DTX or cell DRX, and detailed bit values may vary depending on the embodiment.

The A/D field 945 may be made up of one bit and may include some of the following two types of information:
0: deactivation
1: activation

The above example is characterized in that one bit is used to indicate activation or deactivation of cell DTX or cell DRX, and detailed bit values may vary depending on the embodiment.

If an activation or deactivation indication is received through the TX/RX field and the A/D field with regard to cell DTX or cell DRX not configured for the UE among cell DTX and cell DRX, the UE may ignore the indication through the TX/RX field 940 and the A/D field 945 with regard to the cell DTX or cell DRX not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 950 to indicate at which timepoint the message is to be applied.

The start time field 950 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 950, the UE may apply a value included in the start time field 950 with reference to the closest timepoint among future timepoints indicated by the start time. Obviously, the start time field 950 may have a value indicating instant application of the message.

In an embodiment of the disclosure, the start time field 950 may indicate a timepoint at which corresponding cell DTX or cell DRX is to be activated or deactivated with reference to the period of DTX or DRX. For example, a value in the start time field 950 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 950 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 950 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

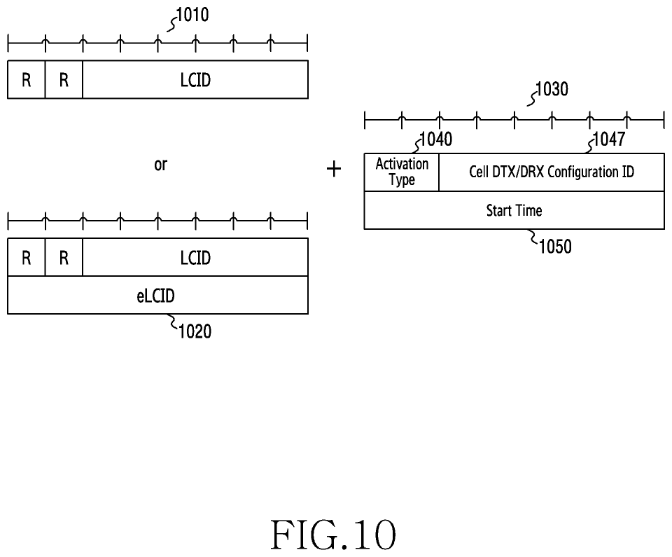

FIG. 10 illustrates a format of a message indicating activation or deactivation of cell DTX or cell DRX, and an operation scheme based thereon according to an embodiment of the disclosure.

Referring to FIG. 10, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 10 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1010. However, in some embodiments of the disclosure, due to the insufficient number of available cases of the LCID field, one value in the eLCID field may indicate that the MAC CE is a message indicating activation or deactivation of cell DTX or cell DRX 1020. A MAC CE 1030 may include at least one of an activation type value indicating whether the UE is actually instructed to activate or deactivate cell DTX or cell DRX, a cell DTX/DRX configuration ID field 1047 indicating the cell DTX or cell DRX to which cell DTX or cell DRX indicated in the message indicating activation or deactivation of corresponding cell DTX or cell DRX is related, and a start time field 1050 indicating the timepoint of actual application of activation or deactivation of cell DTX or cell DRX, activation or deactivation of which has been indicated.

The activation type field 1040 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX among cell DTX or cell DRX configurations indicated by the cell DTX/DRX configuration ID field 1047, the UE may ignore the indication through the activation type field 1040 with regard to a field not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

The cell DTX/DRX configuration ID field 1047 may indicate the cell DTX/DRX configuration to which cell DTX or cell DRX indicated in a message indicating activation or deactivation of corresponding cell DTX or cell DRX is related. The cell DTX/DRX configuration ID value used in the cell DTX/DRX configuration ID field may be configured for the UE by the base station through an RRC message during a cell DTX or cell DRX configuration. One cell DTX/DRX configuration ID value may be configured for one cell DTX or cell DRX. However, multiple cell DTXs and cell DRXs may also share one cell DTX/DRX configuration ID value. In this case, if activation or deactivation of cell DTX or cell DRX is indicated with regard to the cell DTX/DRX configuration ID, activation or deactivation of all cell DTXs and cell DRXs regarding the same cell DTX/DRX configuration ID may be applied. The cell DTX/DRX configuration ID may be uniquely configured in one cell such that, when multiple cell DTXs and cell DRXs are configured in one cell, respective cell DTXs and cell DRXs can be identified. In an embodiment of the disclosure, the cell DTX/DRX configuration ID may be uniquely configured in a cell group (MAC device) having a base station configured therefor or in a UE such that, when multiple cell DTXs and cell DRXs are configured in the cell group (MAC device) or in the UE, respective cell DTXs and cell DRXs can be identified.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 1050 to indicate at which timepoint the message is to be applied.

The start time field 1050 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 1050, the UE may apply a value included in the start time field 1050 with reference to the closest timepoint among future timepoints indicated by the start time. Obviously, the start time field 1050 may have a value indicating instant application of the message.

In an embodiment of the disclosure, the start time field 1050 may indicate a timepoint at which corresponding cell DTX or cell DRX is to be activated or deactivated with reference to the period of DTX or DRX. For example, a value in the start time field 1050 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 1050 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 1050 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

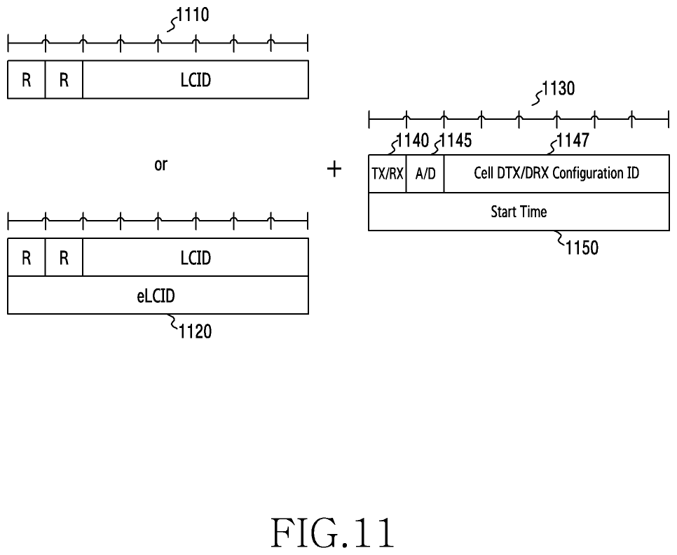

FIG. 11 illustrates a format of a message indicating activation or deactivation of cell DTX or cell DRX, and an operation scheme based thereon according to an embodiment of the disclosure.

Referring to FIG. 11, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 11 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1110. However, in some embodiments of the disclosure, due to the insufficient number of available cases of the LCID field, one value in the eLCID field may indicate that the MAC CE is a message indicating activation or deactivation of cell DTX or cell DRX 1120. A MAC CE 1130 may include at least one of a one-bit TX/RX field value 1140 indicating whether the message indicates activation or deactivation regarding cell DTX or cell DRX, a one-bit A/D field 1145 indicating activation or deactivation with regard to the cell DTX or cell DRX indicated in the TX/RX field, and a cell DTX/DRX configuration ID field 1147 indicating the cell DTX or cell DRX to which cell DTX or cell DRX indicated in the message indicating activation or deactivation of corresponding cell DTX or cell DRX is related. Furthermore, the MAC CE 1130 may include at least one of a start time field 1150 indicating the timepoint of actual application of activation or deactivation of cell DTX or cell DRX, activation or deactivation of which has been indicated.

The TX/RX field 1140 may be made up of one bit and may include some of the following two types of information:
0: cell DTX (downlink)
1: cell DRX (uplink)

The above example is characterized in that one bit is used to indicate cell DTX or cell DRX, and detailed bit values may vary depending on the embodiment.

The A/D field 1145 may be made up of one bit and may include some of the following two types of information:
0: deactivation
1: activation

The above example is characterized in that one bit is used to indicate activation or deactivation of cell DTX or cell DRX, and detailed bit values may vary depending on the embodiment.

The cell DTX/DRX configuration ID field 1147 may indicate the cell DTX/DRX configuration to which cell DTX or cell DRX indicated in a message indicating activation or deactivation of corresponding cell DTX or cell DRX is related. The cell DTX/DRX configuration ID value used in the cell DTX/DRX configuration ID field may be configured for the UE by the base station through an RRC message during a cell DTX or cell DRX configuration. One cell DTX/DRX configuration ID value may be configured for one cell DTX or cell DRX. However, multiple cell DTXs and cell DRXs may also share one cell DTX/DRX configuration ID value. In this case, if activation or deactivation of cell DTX or cell DRX is indicated with regard to the cell DTX/DRX configuration ID, activation or deactivation of all cell DTXs and cell DRXs regarding the same cell DTX/DRX configuration ID may be applied. The cell DTX/DRX configuration ID may be uniquely configured in one cell such that, when multiple cell DTXs and cell DRXs are configured in one cell, respective cell DTXs and cell DRXs can be identified. In an embodiment of the disclosure, the cell DTX/DRX configuration ID may be uniquely configured in a cell group (MAC device) having a base station configured therefor or in a UE such that, when multiple cell DTXs and cell DRXs are configured in the cell group (MAC device) or in the UE, respective cell DTXs and cell DRXs can be identified.

If an activation or deactivation indication is received through the TX/RX field and the A/D field with regard to cell DTX or cell DRX not configured for the UE among cell DTX and cell DRX, the UE may ignore the activation or deactivation indication through the TX/RX field and the A/D field with regard to the cell DTX or cell DRX not configured for the UE among cell DTX and cell DRX. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 1150 to indicate at which timepoint the message is to be applied.

The start time field 1150 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 1150, the UE may apply a value included in the start time field 1150 with reference to the closest timepoint among future timepoints indicated by the start time. Obviously, the start time field 1150 may have a value indicating instant application of the message.

In an embodiment of the disclosure, the start time field 1150 may indicate a timepoint at which corresponding cell DTX or cell DRX is to be activated or deactivated with reference to the period of DTX or DRX. For example, a value in the start time field 1150 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 1150 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 1150 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

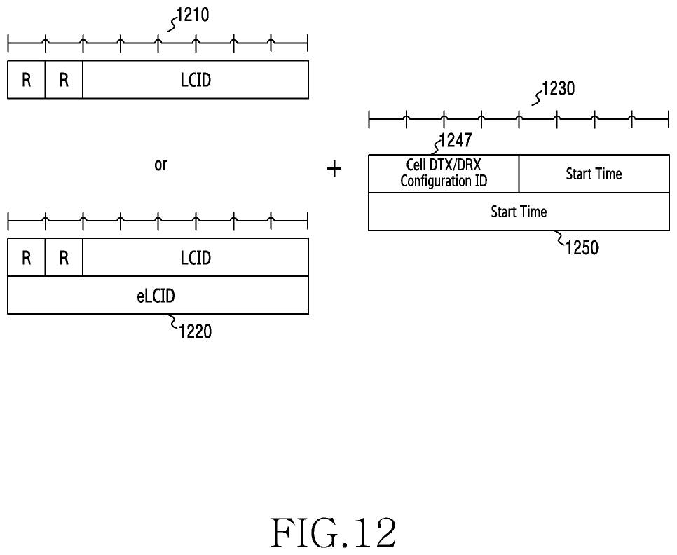

FIG. 12 illustrates a format of a message indicating activation or deactivation of cell DTX or cell DRX, and an operation scheme based thereon according to an embodiment of the disclosure.

Referring to FIG. 12, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 12 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1210. However, in some embodiments of the disclosure, due to the insufficient number of available cases of the LCID field, one value in the eLCID field may indicate that the MAC CE is a message indicating activation or deactivation of cell DTX or cell DRX 1220. A MAC CE 1230 may include at least one of a cell DTX/DRX configuration ID field 1247 indicating the cell DTX or cell DRX to which cell DTX or cell DRX indicated in the message indicating activation or deactivation of corresponding cell DTX or cell DRX is related, and a start time field 1250 indicating the timepoint of actual application of activation or deactivation of cell DTX or cell DRX, activation or deactivation of which has been indicated.

The cell DTX/DRX configuration ID field 1247 may indicate the cell DTX/DRX configuration to which cell DTX or cell DRX indicated in a message indicating activation or deactivation of corresponding cell DTX or cell DRX is related. The cell DTX/DRX configuration ID value used in the cell DTX/DRX configuration ID field may be configured for the UE by the base station through an RRC message during a cell DTX or cell DRX configuration. One cell DTX/DRX configuration ID value may be configured for one cell DTX or cell DRX. However, multiple cell DTXs and cell DRXs may also share one cell DTX/DRX configuration ID value. In this case, if activation or deactivation of cell DTX or cell DRX is indicated with regard to the cell DTX/DRX configuration ID, activation or deactivation of all cell DTXs and cell DRXs regarding the same cell DTX/DRX configuration ID may be applied. The cell DTX/DRX configuration ID may be uniquely configured in one cell such that, when multiple cell DTXs and cell DRXs are configured in one cell, respective cell DTXs and cell DRXs can be identified. In an embodiment of the disclosure, the cell DTX/DRX configuration ID may be uniquely configured in a cell group (MAC device) having a base station configured therefor or in a UE such that, when multiple cell DTXs and cell DRXs are configured in the cell group (MAC device) or in the UE, respective cell DTXs and cell DRXs can be identified.

The cell DTX/DRX configuration ID may have at least one value indicating deactivation of cell DTX and cell DRX. Upon receiving a message including a cell DTX/DRX configuration ID value indicating deactivation of cell DTX and cell DRX, the UE may deactivate both cell DTX and cell DRX in the corresponding cell. In an embodiment of the disclosure, the cell DTX/DRX configuration ID may have at least one value indicating deactivation of cell DTX. Upon receiving a message including a cell DTX/DRX configuration ID value indicating deactivation of cell DTX, the UE may deactivate the cell DTX configured in the corresponding cell. In some embodiments of the disclosure, the cell DTX/DRX configuration ID may have at least one value indicating deactivation of cell DRX. Upon receiving a message including a cell DTX/DRX configuration ID value indicating deactivation of cell DRX, the UE may deactivate the cell DRX configured in the corresponding cell.

If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 1250 to indicate at which timepoint the message is to be applied.

The start time field 1250 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 1250, the UE may apply a value included in the start time field 1250 with reference to the closest timepoint among future timepoints indicated by the start time. Obviously, the start time field 1250 may have a value indicating instant application of the message.

In an embodiment of the disclosure, the start time field 1250 may indicate a timepoint at which corresponding cell DTX or cell DRX is to be activated or deactivated with reference to the period of DTX or DRX. For example, a value in the start time field 1250 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 1250 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 1250 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

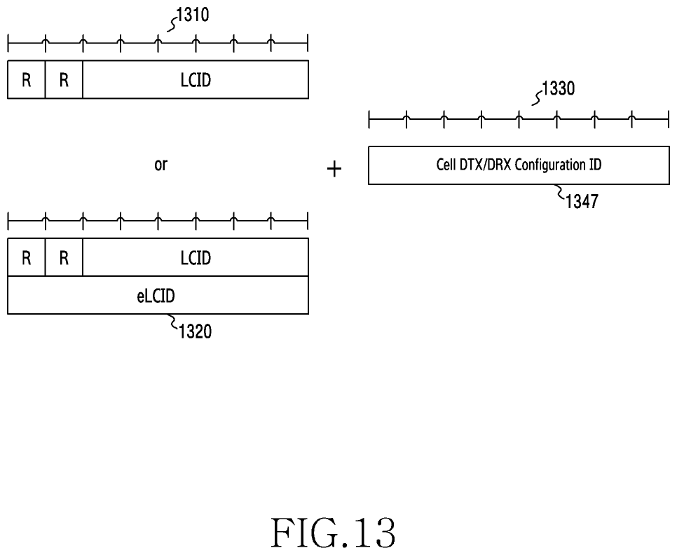

FIG. 13 illustrates a format of a message indicating activation or deactivation of cell DTX or cell DRX, and an operation scheme based thereon according to an embodiment of the disclosure.

Referring to FIG. 13, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 13 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1310. However, in some embodiments of the disclosure, due to the insufficient number of available cases of the LCID field, one value in the eLCID field may indicate that the MAC CE is a message indicating activation or deactivation of cell DTX or cell DRX 1320. A MAC CE 1330 may include a cell DTX/DRX configuration ID field 1347 indicating the cell DTX or cell DRX to which cell DTX or cell DRX indicated in the message indicating activation or deactivation of corresponding cell DTX or cell DRX is related.

The cell DTX/DRX configuration ID field 1347 may indicate the cell DTX/DRX configuration to which cell DTX or cell DRX indicated in a message indicating activation or deactivation of corresponding cell DTX or cell DRX is related. The cell DTX/DRX configuration ID value used in the cell DTX/DRX configuration ID field may be configured for the UE by the base station through an RRC message during a cell DTX or cell DRX configuration. One cell DTX/DRX configuration ID value may be configured for one cell DTX or cell DRX. However, multiple cell DTXs and cell DRXs may also share one cell DTX/DRX configuration ID value. In this case, if activation or deactivation of cell DTX or cell DRX is indicated with regard to the cell DTX/DRX configuration ID, activation or deactivation of all cell DTXs and cell DRXs regarding the same cell DTX/DRX configuration ID may be applied. The cell DTX/DRX configuration ID may be uniquely configured in one cell such that, when multiple cell DTXs and cell DRXs are configured in one cell, respective cell DTXs and cell DRXs can be identified. In an embodiment of the disclosure, the cell DTX/DRX configuration ID may be uniquely configured in a cell group (MAC device) having a base station configured therefor or in a UE such that, when multiple cell DTXs and cell DRXs are configured in the cell group (MAC device) or in the UE, respective cell DTXs and cell DRXs can be identified.

The cell DTX/DRX configuration ID may have at least one value indicating deactivation of cell DTX and cell DRX. Upon receiving a message including a cell DTX/DRX configuration ID value indicating deactivation of cell DTX and cell DRX, the UE may deactivate both cell DTX and cell DRX in the corresponding cell. In an embodiment of the disclosure, the cell DTX/DRX configuration ID may have at least one value indicating deactivation of cell DTX. Upon receiving a message including a cell DTX/DRX configuration ID value indicating deactivation of cell DTX, the UE may deactivate the cell DTX configured in the corresponding cell. In some embodiments of the disclosure, the cell DTX/DRX configuration ID may have at least one value indicating deactivation of cell DRX. Upon receiving a message including a cell DTX/DRX configuration ID value indicating deactivation of cell DRX, the UE may deactivate the cell DRX configured in the corresponding cell.

If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

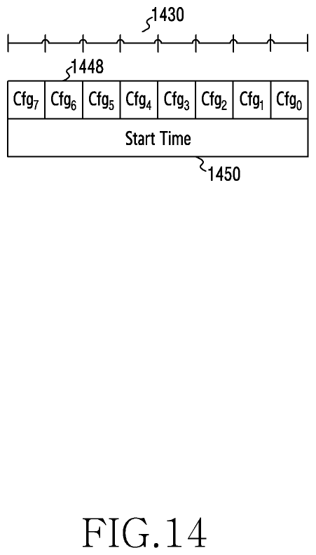

FIG. 14 illustrates a format of a message indicating activation or deactivation of cell DTX or cell DRX, and an operation scheme based thereon according to an embodiment of the disclosure.

Referring to FIG. 14, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 14 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in some embodiments of the disclosure, due to the insufficient number of available cases of the LCID field, one value in the eLCID field may indicate that the MAC CE is a message indicating activation or deactivation of cell DTX or cell DRX. A MAC CE 1430 may include at least one of a configuration (cfg)i bitmap 1448 indicating the cell DTX or cell DRX configuration to which cell DTX or cell DRX indicated in a message indicating activation or deactivation of corresponding cell DTX or cell DRX is related, and a start time field 1450 indicating the timepoint of actual application of activation or deactivation of cell DTX or cell DRX, activation or deactivation of which has been indicated.

The cfgi bitmap 1448 may indicate the cell DTX or cell DRX configuration to which cell DTX or cell DRX indicated in a message indicating activation or deactivation of corresponding cell DTX or cell DRX is related. Each bit in the cfgi field may indicate activation or deactivation of cell DTX or cell DRX indicated by index i. In an embodiment of the disclosure, index i may be a value corresponding to cell DTX or cell DRX configured for the UE. In this case, the cfgi value may indicate activation or deactivation with regard to cell DTX or cell DRX corresponding to index i. For example, the cfgi field value of 0 may mean that cell DTX or cell DRX corresponding to index i is to be deactivated, and the cfgi field value of 1 may mean that cell DTX or cell DRX corresponding to index i is to be activated. The length of cfgi field may vary depending on the number of cell DTXs or cell DRXs configured for the UE or cell. The index i may be configured by an RRC message and used for a message indicating activation or deactivation of cell DTX or cell DRX. If there are two or more cells, and if the value indicated by the cfgi field indicates activation or deactivation corresponding two or more cell DTXs or cell DRXs, a message indicating activation or deactivation of cell DTX or cell DRX may apply activation or deactivation of the two or more cell DTXs or cell DRXs.

If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 1450 to indicate at which timepoint the message is to be applied.

The start time field 1450 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 1450, the UE may apply a value included in the start time field 1450 with reference to the closest timepoint among future timepoints indicated by the start time. Obviously, the start time field 1450 may have a value indicating instant application of the message.

In an embodiment of the disclosure, the start time field 1450 may indicate a timepoint at which corresponding cell DTX or cell DRX is to be activated or deactivated with reference to the period of DTX or DRX. For example, a value in the start time field 1450 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 1450 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 1450 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

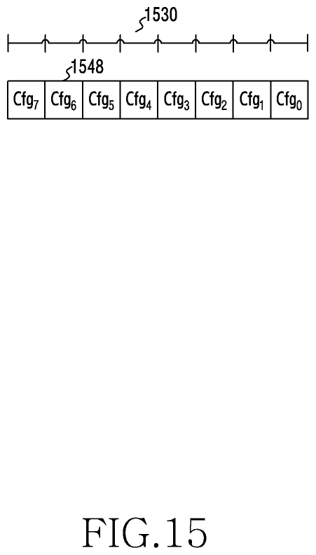

FIG. 15 illustrates a format of a message indicating activation or deactivation of cell DTX or cell DRX, and an operation scheme based thereon according to an embodiment of the disclosure.

Referring to FIG. 15, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 15 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in some embodiments of the disclosure, due to the insufficient number of available cases of the LCID field, one value in the eLCID field may indicate that the MAC CE is a message indicating activation or deactivation of cell DTX or cell DRX. A MAC CE 1530 may include a configuration (cfg)i bitmap 1548 indicating the cell DTX or cell DRX configuration to which cell DTX or cell DRX indicated in a message indicating activation or deactivation of corresponding cell DTX or cell DRX is related.

The cfgi bitmap 1548 may indicate the cell DTX or cell DRX configuration to which cell DTX or cell DRX indicated in a message indicating activation or deactivation of corresponding cell DTX or cell DRX is related. Each bit in the cfgi field may indicate activation or deactivation of cell DTX or cell DRX indicated by index i. In an embodiment of the disclosure, index i may be a value corresponding to cell DTX or cell DRX configured for the UE. In this case, the cfgi value may indicate activation or deactivation with regard to cell DTX or cell DRX corresponding to index i. For example, the cfgi field value of 0 may mean that cell DTX or cell DRX corresponding to index i is to be deactivated, and the cfgi field value of 1 may mean that cell DTX or cell DRX corresponding to index i is to be activated. The length of cfgi field may vary depending on the number of cell DTXs or cell DRXs configured for the UE or cell. The index i may be configured by an RRC message and used for a message indicating activation or deactivation of cell DTX or cell DRX. If there are two or more cells, and if the value indicated by the cfgi field indicates activation or deactivation corresponding two or more cell DTXs or cell DRXs, a message indicating activation or deactivation of cell DTX or cell DRX may apply activation or deactivation of the two or more cell DTXs or cell DRXs.

If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

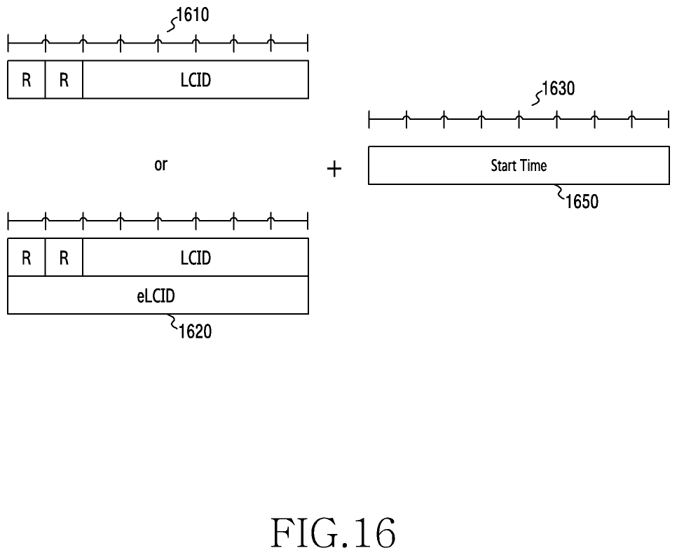

FIG. 16 illustrates a format of a message indicating activation or deactivation of cell DTX or cell DRX, and an operation scheme based thereon according to an embodiment of the disclosure.

Referring to FIG. 16, it illustrates an embodiment of the format of the message indicating activation or deactivation of cell DTX or cell DRX transmitted in operation 320. FIG. 16 illustrates an embodiment wherein a message indicating activation or deactivation of cell DTX or cell DRX is transmitted in a MAC CE format. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1610. However, in some embodiments of the disclosure, due to the insufficient number of available cases of the LCID field, one value in the eLCID field may indicate that the MAC CE is a message indicating activation or deactivation of cell DTX or cell DRX 1620. One value in the LCID or eLCID field may indicate that an accompanying MAC CE 1630 is a message indicating one of the following:
cell DTX and cell DRX are both deactivated
cell DTX is activated, and cell DRX is deactivated
cell DTX is deactivated, and cell DRX is activated
cell DTX and cell DRX are both activated

In another embodiment of the disclosure, one value in the LCID or eLCID field may indicate that the accompanying MAC CE 1630 is a message indicating one of the following:
cell DTX is deactivated
cell DTX is activated
cell DRX is deactivated
cell DRX is activated

The MAC CE 1630 may include a start time field 1650 indicating the timepoint of actual application of activation or deactivation of cell DTX or cell DRX, activation or deactivation of which has been indicated. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 1650 to indicate at which timepoint the message is to be applied.

The start time field 1650 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field 1650, the UE may apply a value included in the start time field 1650 with reference to the closest timepoint among future timepoints indicated by the start time. Obviously, the start time field 1650 may have a value indicating instant application of the message.

In an embodiment of the disclosure, the start time field 1650 may indicate a timepoint at which corresponding cell DTX or cell DRX is to be activated or deactivated with reference to the period of DTX or DRX. For example, a value in the start time field 1650 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 1650 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 1650 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

In an embodiment of the disclosure, if no start time field is included in the message indicating activation or deactivation of cell DTX or cell DRX in FIG. 16, there may be no information actually included in the MAC CE. In this case, a zero-byte MAC CE (MAC CE the size of which is 0) may be transmitted. Alternatively, the LCID field or eLCID field may indicate activation or deactivation of cell DTX or cell DRX. If an activation or deactivation indication is received through the MAC CE illustrated in FIG. 16 with regard to a field not configured for the UE among cell DTX and cell DRX, the UE may ignore this field. On the other hand, if the same activation indication is received with regard to already activated cell DTX or cell DRX, the UE may maintain the current activation and deactivation states.

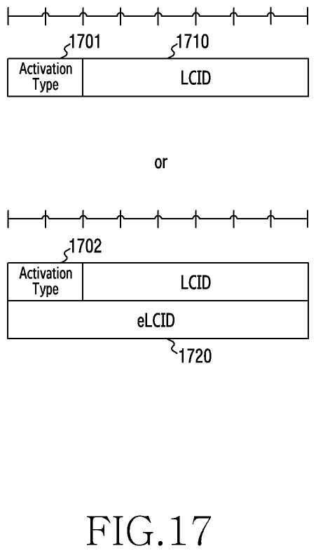

FIG. 17 illustrates a format of a message indicating activation or deactivation of cell DTX or cell DRX, and an operation scheme based thereon according to an embodiment of the disclosure.

Referring to FIG. 17, it illustrates an embodiment of the format of the message indicating activation or deactivation of cell DTX or cell DRX transmitted in operation 320. FIG. 17 illustrates an embodiment wherein a message indicating activation or deactivation of cell DTX or cell DRX is transmitted in a MAC CE format. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1710. However, in some embodiments of the disclosure, due to the insufficient number of available cases of the LCID field, one value in the eLCID field may indicate that the MAC CE is a message indicating activation or deactivation of cell DTX or cell DRX 1720. Furthermore, the MAC sub-header may include an activation type field 1701 or 1702 indicating whether the UE is actually instructed to activate or deactivate cell DTX or cell DRX. Although the position of the activation type field has been used in the MAC sub-header as a reserved (R) field or format (F) field, the same may be used as an activation type field if an LCID or eLCID value is used to indicate activation or deactivation of cell DTX or cell DRX.

The activation type field 1701 or 1702 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX, the UE may ignore the field. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment of the disclosure, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

In some embodiments of the disclosure, if no start time field is included in the message indicating activation or deactivation of cell DTX or cell DRX in FIG. 17, there may be no information actually included in the MAC CE. In this case, a zero-byte MAC CE (MAC CE the size of which is 0) may be transmitted.

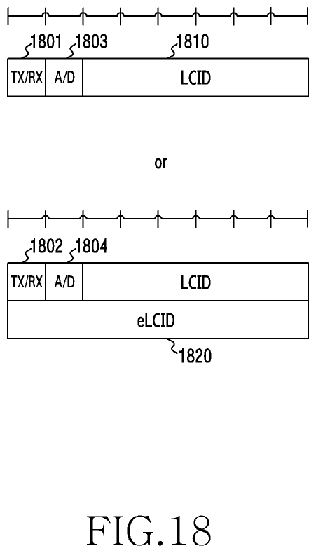

FIG. 18 illustrates a format of a message indicating activation or deactivation of cell DTX or cell DRX, and an operation scheme based thereon according to an embodiment of the disclosure.

Referring to FIG. 18, it illustrates an embodiment of the format of the message indicating activation or deactivation of cell DTX or cell DRX transmitted in operation 320. FIG. 18 illustrates an embodiment wherein a message indicating activation or deactivation of cell DTX or cell DRX is transmitted in a MAC CE format. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX 1810. However, in an embodiment of the disclosure, due to the insufficient number of available cases of the LCID field, one value in the eLCID field may indicate that the MAC CE is a message indicating activation or deactivation of cell DTX or cell DRX 1820. Furthermore, the MAC sub-header may include at least one of a one-bit TX/RX field value 1801 or 1802 indicating whether the message indicates activation or deactivation regarding cell DTX or cell DRX, and a one-bit A/D field 1803 or 1804 indicating activation or deactivation with regard to the cell DTX or cell DRX indicated in the TX/RX field. Although the position of the activation type field has been used in the MAC sub-header as a reserved (R) field or format (F) field, the same may be used as an activation type field if an LCID or eLCID value is used to indicate activation or deactivation of cell DTX or cell DRX.

The TX/RX field 1801 or 1802 may be made up of one bit and may include some of the following two types of information:
0: cell DTX (downlink)
1: cell DRX (uplink)

The above example is characterized in that one bit is used to indicate cell DTX or cell DRX, and detailed bit values may vary depending on the embodiment.

The A/D field 1803 or 1804 may be made up of one bit and may include some of the following two types of information:
0: deactivation
1: activation

The above example is characterized in that one bit is used to indicate activation or deactivation of cell DTX or cell DRX, and detailed bit values may vary depending on the embodiment.

If an activation or deactivation indication is received through the TX/RX field 1801 or 1802 and the A/D field 1803 or 1804 with regard to cell DTX or cell DRX not configured for the UE among cell DTX and cell DRX, the UE may ignore the TX/RX field 1801 or 1802 and the A/D field 1803 or 1804 with regard to the cell DTX or cell DRX not configured for the UE. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment materially, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment materially, the timepoint of actual application after a message indicating activation and deactivation of corresponding cell DTX and cell DRX is received may be included in an RRC message and transmitted. In addition, in an embodiment materially, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

In some embodiments of the disclosure, if no start time field is included in the message indicating activation or deactivation of cell DTX or cell DRX in FIG. 18, there may be no information actually included in the MAC CE. In this case, a zero-byte MAC CE (MAC CE the size of which is 0) may be transmitted.

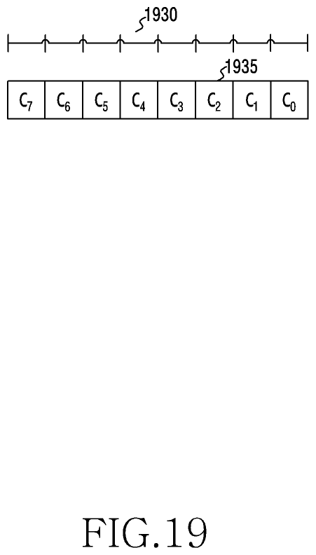

FIG. 19 illustrates a format of a message indicating activation or deactivation of cell DTX or cell DRX, and an operation scheme based thereon according to an embodiment of the disclosure.

Referring to FIG. 19, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 19 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in an embodiment materially, due to the insufficient number of available cases of the LCID field, one value in the eLCID field may indicate that the MAC CE is a message indicating activation or deactivation of cell DTX or cell DRX. A MAC CE 1930 may include a Ci bitmap 1935 indicating activation and deactivation of cell DTX or cell DRX indicated in a message indicating activation or deactivation of corresponding cell DTX or cell DRX.

The Ci bitmap 1935 may indicate the cell to which cell DTX or cell DRX indicated in a message indicating activation or deactivation of corresponding cell DTX or cell DRX is related. Each bit in the Ci field may indicate whether cell DTX or cell DRX is to be activated or deactivated with regard to the cell indicated by index i. In an embodiment materially, index i may be a serving cell ID corresponding to a cell configured for the UE. In this case, Ci may indicate whether activation or deactivation of cell DTX or cell DRX is indicated with regard to the cell, the serving cell ID of which is i. For example, the Ci field value of 1 means that cell DTX and cell DRX configured for the cell having index i are to be activated. The Ci field value of 0 means that cell DTX and cell DRX configured for the cell having index i are to be deactivated. If an activation or deactivation indication is received through the Ci field with regard to cell DTX or cell DRX not configured for the UE among cell DTX and cell DRX, the UE may ignore the activation or deactivation indication through the Ci field with regard to cell DTX or cell DRX not configured therefor. On the other hand, if the same activation indication is received with regard to already activated cell DTX or cell DRX, the UE may maintain the current activation and deactivation states.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment materially, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

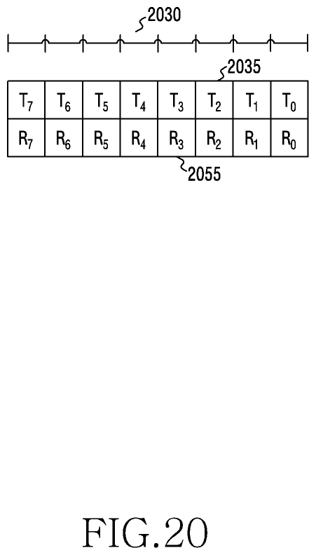

FIG. 20 illustrates a format of a message indicating activation or deactivation of cell DTX or cell DRX, and an operation scheme based thereon according to an embodiment of the disclosure.

Referring to FIG. 20, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 20 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in an embodiment of the disclosure, due to the insufficient number of available cases of the LCID field, one value in the eLCID field may indicate that the MAC CE is a message indicating activation or deactivation of cell DTX or cell DRX. A MAC CE 2030 may include a Ti bitmap 2035 indicating activation and deactivation of cell DTX indicated in a message indicating activation or deactivation of corresponding cell DTX or cell DRX, and a Ri bitmap 2055 indicating activation and deactivation of cell DRX. The embodiment in FIG. 20 is characterized in that cell DTX and cell DRX are indicated and applied by using different bitmaps with regard to respective cells.

The Ti bitmap 2035 may indicate the cell to which cell DTX indicated in a message indicating activation or deactivation of corresponding cell DTX is related. Each bit in the Ti field may indicate whether activation or deactivation of cell DTX is to be applied with regard to the cell indicated by index i. In an embodiment of the disclosure, index i may be a serving cell ID corresponding to a cell configured for the UE. In this case, Ti may indicate whether activation or deactivation of cell DTX is indicated with regard to the cell, the serving cell ID of which is i. For example, the Ti field value of 1 may mean that cell DTX configured for the cell having index i is to be activated. The Ti field value of 0 means that cell DTX configured for the cell having index i is to be deactivated. If an activation or deactivation indication is received through the Ti field with regard to cell DTX not configured for the UE among cell DTXs, the UE may ignore the activation or deactivation indication through the Ti field with regard to cell DTX not configured therefor. On the other hand, if the same activation indication is received with regard to already activated cell DTX, the UE may maintain the current activation and deactivation states.

The Ri bitmap 2055 may indicate the cell to which cell DRX indicated in a message indicating activation or deactivation of corresponding cell DRX is related. Each bit in the Ri field may indicate whether activation or deactivation of cell DRX is to be applied with regard to the cell indicated by index i. In an embodiment of the disclosure, index i may be a serving cell ID corresponding to a cell configured for the UE. In this case, Ri may indicate whether activation or deactivation of cell DRX is indicated with regard to the cell, the serving cell ID of which is i. For example, the Ri field value of 1 means that cell DRX configured for the cell having index i is to be activated. The Ri field value of 0 means that cell DRX configured for the cell having index i is to be deactivated. If an activation or deactivation indication is received through the Ri field with regard to cell DRX not configured for the UE among cell DRXs, the UE may ignore the activation or deactivation indication through the Ri field with regard to cell DRX not configured therefor. On the other hand, if the same activation indication is received with regard to already activated cell DRX, the UE may maintain the current activation and deactivation states.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment of the disclosure, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

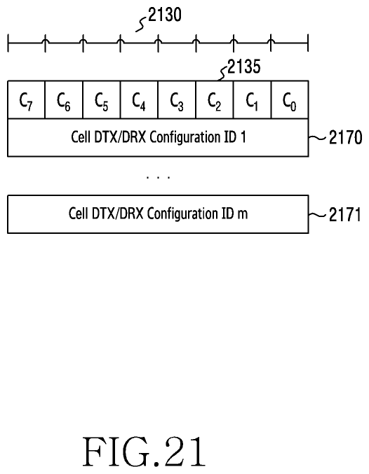

FIG. 21 illustrates a format of a message indicating activation or deactivation of cell DTX or cell DRX, and an operation scheme based thereon according to an embodiment of the disclosure.

Referring to FIG. 21, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 21 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in an embodiment of the disclosure, due to the insufficient number of available cases of the LCID field, one value in the eLCID field may indicate that the MAC CE is a message indicating activation or deactivation of cell DTX or cell DRX. A MAC CE 2130 may include at least one of a Ci bitmap 2135 indicating the cell to which cell DTX or cell DRX indicated in a message indicating activation or deactivation of corresponding cell DTX or cell DRX is related, and a cell DTX/DRX configuration identity (ID) field 2170 or 2171 indicating which cell DTX or cell DRX is to be activated or deactivated among cell DTX or cell DRX configurations configured for the cell indicated by the Ci bitmap.

The Ci bitmap 2135 may indicate the cell to which cell DTX or cell DRX indicated in a message indicating activation or deactivation of corresponding cell DTX or cell DRX is related. Each bit in the Ci field may indicate whether cell DTX or cell DRX is to be activated or deactivated with regard to the cell indicated by index i. In an embodiment of the disclosure, index i may be a serving cell ID corresponding to a cell configured for the UE. In this case, Ci may indicate whether activation or deactivation of cell DTX or cell DRX is indicated with regard to the cell, the serving cell ID of which is i. For example, the Ci field value of 0 means that the activation and deactivation states of cell DTX and cell DRX are not changed with regard to the cell indicated by index i. If the Ci field value is 1, information regarding activation or deactivation of cell DTX or cell DRX related to the cell indicated by index i may be applied according to remaining field values of the message. The length of the Ci field may vary depending on the serving cell ID configured for the UE. In an embodiment of the disclosure, index i may be configured by an RRC message and used for the message. With regard to a cell having 1 configured in the Ci field, a cell DTX/DRX configuration ID field may be added later to indicate activation or deactivation of cell DTX or cell DRX of the corresponding cell.

The cell DTX/DRX configuration ID field 2170 or 2171 may indicate the cell DTX/DRX configuration to which cell DTX or cell DRX indicated in a message indicating activation or deactivation of corresponding cell DTX or cell DRX is related. The cell DTX/DRX configuration ID value used in the cell DTX/DRX configuration ID field may be configured for the UE by the base station through an RRC message during a cell DTX or cell DRX configuration. One cell DTX/DRX configuration ID value may be configured for one cell DTX or cell DRX. However, one cell DTX and one cell DRX may also share one cell DTX/DRX configuration ID value. In this case, if activation or deactivation of cell DTX and cell DRX is indicated with regard to the cell DTX/DRX configuration ID, activation or deactivation of cell DTX and cell DRX regarding the same cell DTX/DRX configuration ID may be applied. The cell DTX/DRX configuration ID may be uniquely configured in one cell such that, when multiple cell DTXs and cell DRXs are configured in one cell, respective cell DTXs and cell DRXs can be identified.

The cell DTX/DRX configuration ID may have at least one value indicating deactivation of cell DTX and cell DRX. Upon receiving a message including a cell DTX/DRX configuration ID value indicating deactivation of cell DTX and cell DRX, the UE may deactivate both cell DTX and cell DRX in the corresponding cell. In an embodiment of the disclosure, the cell DTX/DRX configuration ID may have at least one value indicating deactivation of cell DTX. Upon receiving a message including a cell DTX/DRX configuration ID value indicating deactivation of cell DTX, the UE may deactivate the cell DTX configured in the corresponding cell. In an embodiment of the disclosure, the cell DTX/DRX configuration ID may have at least one value indicating deactivation of cell DRX. Upon receiving a message including a cell DTX/DRX configuration ID value indicating deactivation of cell DRX, the UE may deactivate the cell DRX configured in the corresponding cell.

In the embodiment in FIG. 21, the MAC CE 2130 is illustrated as including a cell DTX/DRX configuration ID field with regard to a cell having a Ci field configured as 1. In other words, in the case of a cell having a Ci field configured as 0, there is no need to change the activation or deactivation state of cell DTX or cell DRX, and no cell DTX/DRX configuration ID field thus needs to be included in the corresponding MAC CE. For example, the cell DTX/DRX configuration ID field may not be included. In some embodiments of the disclosure, in the case of a cell having a Ci field configured as 1, the cell DTX/DRX configuration ID field may be included in ascending order of index i. Obviously, the above example is not limitative.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment of the disclosure, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

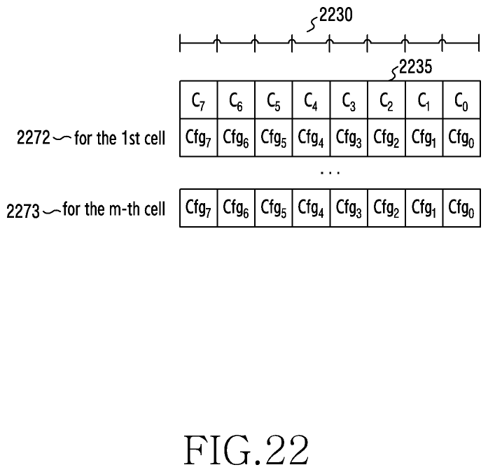

FIG. 22 illustrates a format of a message indicating activation or deactivation of cell DTX or cell DRX, and an operation scheme based thereon according to an embodiment of the disclosure.

Referring to FIG. 22, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 22 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in an embodiment of the disclosure, due to the insufficient number of available cases of the LCID field, one value in the eLCID field may indicate that the MAC CE is a message indicating activation or deactivation of cell DTX or cell DRX. A MAC CE 2230 may include at least one of a Ci bitmap 2235 indicating the cell to which cell DTX or cell DRX indicated in a message indicating activation or deactivation of corresponding cell DTX or cell DRX is related, and a configuration (cfg)j bitmap 2272 or 2273 indicating which cell DTX or cell DRX is to be activated or deactivated in the cell indicated by the Ci field.

The Ci bitmap 2235 may indicate the cell to which cell DTX or cell DRX indicated in a message indicating activation or deactivation of corresponding cell DTX or cell DRX is related. Each bit in the Ci field may indicate activation or deactivation of cell DTX or cell DRX with regard to the cell indicated by index i. In an embodiment of the disclosure, index i may be a serving cell ID corresponding to a cell configured for the UE. In this case, Ci may indicate whether activation or deactivation of cell DTX or cell DRX is indicated with regard to the cell, the serving cell ID of which is i. For example, the Ci field value of 0 means that the activation and deactivation states of cell DTX and cell DRX are not changed with regard to the cell indicated by index i. If the Ci field value is 1, information regarding activation or deactivation of cell DTX or cell DRX related to the cell indicated by index i may be applied according to remaining field values of the message. The length of the Ci field may vary depending on the serving cell ID configured for the UE. In an embodiment of the disclosure, index i may be configured by an RRC message and used for the message. With regard to a cell having 1 configured in the Ci field, a cfgj bitmap field may be added later to indicate activation or deactivation of cell DTX or cell DRX of the corresponding cell.

The cfgj bitmap 2272 or 2273 may indicate the cell DTX or cell DRX configuration to which cell DTX or cell DRX indicated in a message indicating activation or deactivation of corresponding cell DTX or cell DRX is related. With regard to cell DTX or cell DRX having index j configured for a cell having the Ci field configured as 1, the cfgj field value may indicate activation or deactivation of corresponding cell DTX or cell DRX. In an embodiment of the disclosure, index j may be a value corresponding to cell DTX or cell DRX configured for the UE. In this case, the cfgj value may indicate activation or deactivation with regard to cell DTX or cell DRX corresponding to index j. For example, the cfgj field value of 0 may mean that cell DTX or cell DRX corresponding to index j is to be deactivated, and the cfgj field value of 1 may mean that cell DTX or cell DRX corresponding to index j is to be activated. The length of cfgj field may vary depending on the number of cell DTXs or cell DRXs configured for the UE or cell. The index j may be configured by an RRC message and used for the message.

In the embodiment in FIG. 22, the MAC CE 2230 is illustrated as including a cfgj bitmap with regard to a cell having a Ci field configured as 1. In other words, in the case of a cell having a Ci field configured as 0, there is no need to change the activation or deactivation state of cell DTX or cell DRX, and no cfgj bitmap thus needs to be included in the corresponding MAC CE. For example, the cfgj bitmap may not be included. In some embodiments of the disclosure, in the case of a cell having a Ci field configured as 1, a cfgj bitmap regarding cell i may be included in ascending order of index i.

The MAC CE may include a start time indicating the timepoint of actual application of activation or deactivation of cell DTX or cell DRX, activation or deactivation of which has been indicated. Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field to indicate at which timepoint the message is to be applied.

The start time field may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field or the like, the SFN, subframe number, and slot number values may be partially included. For example, the most significant bit (MSB) or least significant bit (LSB) value of the SFN may be included. Upon receiving a message including the start time field, the UE may apply a value included in the start time field with reference to the closest timepoint among future timepoints indicated by the start time. Obviously, the start time field may have a value indicating instant application of the message.

In an embodiment of the disclosure, the start time field may indicate a timepoint at which corresponding cell DTX or cell DRX is to be activated or deactivated with reference to the period of DTX or DRX. For example, a value in the start time field may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

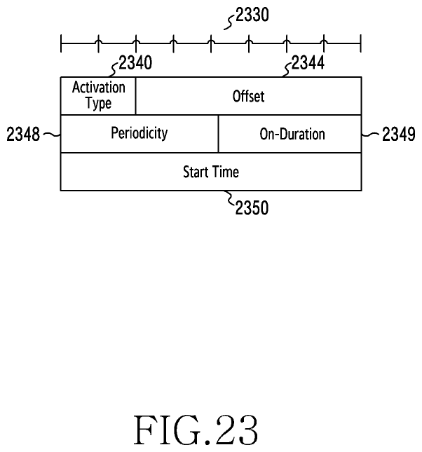

FIG. 23 illustrates a format of a message indicating activation or deactivation of cell DTX or cell DRX, and an operation scheme based thereon according to an embodiment of the disclosure.

Referring to FIG. 23, it illustrates an embodiment of the format of the message indicating activation or deactivation of cell DTX or cell DRX transmitted in operation 320. Although a message indicating activation or deactivation of cell DTX or cell DRX is illustrated in the embodiment in FIG. 23 in a MAC CE format, the message may be transmitted in a DCI format, and the information included therein and the UE operation may be identical. A MAC sub-header may be included such that a MAC CE is transmitted, and the MAC sub-header may include a logical channel identity (LCID) field or eLCID field to specify the MCE CE. One value in the LCID field may indicate that the MAC CE is a message indicating activation or deactivation of cell DTX or cell DRX. However, in some embodiments of the disclosure, due to the insufficient number of available cases of the LCID field, one value in the eLCID field may indicate that the MAC CE is a message indicating activation or deactivation of cell DTX or cell DRX. A MAC CE 2330 may include at least one of an activation type value 2340 indicating whether the UE is actually instructed to activate or deactivate cell DTX or cell DRX, an offset value 2344 of indicated cell DTX or cell DRX, a periodicity 2348, an on-duration 2349, and a start time field 2350 indicating the timepoint of application of activation or deactivation.

The activation type field 2340 may be made up of two bits and may include some of the following four types of information:
00: cell DTX deactivation, cell DRX deactivation
10: cell DTX activation, cell DRX deactivation
01: cell DTX deactivation, cell DRX activation
11: cell DTX activation, cell DRX activation

The above example is characterized in that two bits are used to indicate four cases corresponding to four kinds of activation or deactivation of cell DTX or cell DRX, and detailed bit values may vary depending on the embodiment. If an activation or deactivation indication is received through the activation type field with regard to a field not configured for the UE among cell DTX and cell DRX, the UE may ignore the indication through the activation type field with regard to a field not configured for the UE. On the other hand, if the same activation indication is received with regard to already activated cell DTX or cell DRX, the UE may maintain the current activation and deactivation states. If the UE has multiple cells configured therefor according to carrier aggregation or the like, activation or deactivation of cell DTX and cell DRX may be applied to a cell which received a message indicating activation or deactivation of cell DTX or cell DRX. In an embodiment of the disclosure, with regard to a cell which received DCI indicating a message indicating activation or deactivation of cell DTX or cell DRX, activation or deactivation of corresponding cell DTX or cell DRX may be applied. In addition, in an embodiment of the disclosure, activation or deactivation of corresponding cell DTX or cell DRX may be applied to all cells of a cell group or DRX group configured for the UE.

In the embodiment in FIG. 23, a message indicating activation or deactivation of cell DTX or cell DRX is illustrated as indicating a part of configuration information of cell DTX or cell DRX. Such configuration information of cell DTX or cell DRX may be at least one of an offset value 2344, a periodicity 2348, an on-duration 2349, and a start time field 2350.

Assuming that multiple UEs in a base station, a message indicating activation or deactivation of cell DTX or cell DRX is transmitted to each UE, or a message indicating activation or deactivation of cell DTX or cell DRX is transmitted through group transmission which uses a group-radio network temporary identity (G-RNTI), UEs connected to a cell may then receive the message indicating activation or deactivation of cell DTX or cell DRX at different timepoints due to retransmission or the like. However, activation and deactivation of cell DTX and cell DRX may occur at a specific timepoint of the base station. In other words, the timepoint at which a UE receives a message indicating activation and deactivation of cell DTX and cell DRX may not be the timepoint at which the base station actually performs activation or deactivation of cell DTX and cell DRX. To this end, the message transmitted from the base station to a UE to indicate activation or deactivation of cell DTX or cell DRX may include a start time field 2350 to indicate at which timepoint the message is to be applied.

The start time field 2350 may indicate the timepoint at which activation or deactivation of cell DTX or cell DRX indicated in the message is started. Values of the start time may include a specific system frame number (SFN), a subframe number, a slot number, and the like. Obviously, the above example is not limitative, and if the SFN value or the like cannot be used due to a problem regarding the size of the start time field 2350 or the like, the SFN, subframe number, and slot number values may be partially included. For example, the most significant bit (MSB) or least significant bit (LSB) value of the SFN may be included. Upon receiving a message including the start time field 2350, the UE may apply a value included in the start time field 2350 with reference to the closest timepoint among future timepoints indicated by the start time. Obviously, the start time field 2350 may have a value indicating instant application of the message.

In an embodiment of the disclosure, the start time field 2350 may indicate a timepoint at which corresponding cell DTX or cell DRX is to be activated or deactivated with reference to the period of DTX or DRX. For example, a value in the start time field 2350 may indicate after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The UE may apply activation or deactivation of corresponding cell DTX or cell DRX at a starting timepoint of the cell DTX or cell DRX period indicated by the start time field 2350 or at a starting timepoint to which an offset is applied, based on information regarding after what numbered cell DTX or cell DRX period activation or deactivation of the indicated cell DTX or cell DRX is to be applied with reference to the timepoint at which the UE received a message indicating activation and deactivation of corresponding cell DTX and cell DRX. The start time field 2350 may have a value indicating instant application of the message. In an embodiment of the disclosure, the timepoint of actual application after a message indicating activation and deactivation of corresponding cell DTX and cell DRX is received may be included in an RRC message and transmitted. In addition, in an embodiment of the disclosure, after a message indicating activation and deactivation of corresponding cell DTX and cell DRX is received, indicated activation or deactivation may be applied at the starting timepoint of the next period of corresponding cell DTX or cell DRX (or at a starting timepoint at which an offset is applied).

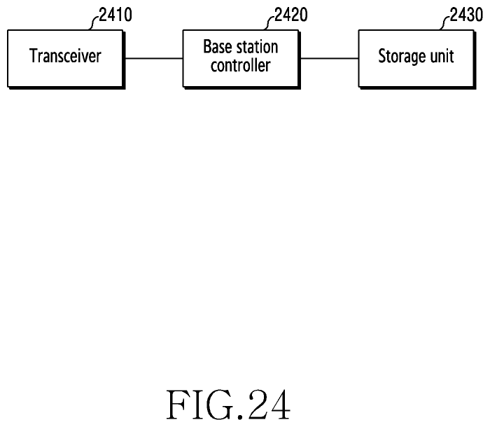

FIG. 24 illustrates a structure of a base station according to an embodiment of the disclosure.

Referring to FIG. 24, the base station may include a transceiver 2410, a base station controller 2420, and a storage unit 2430. The transceiver 2410, the base station controller 2420, and the storage unit 2430 may operate according to the above-described base station communication method. In addition, a network device may correspond to the structure of the base station. However, components of the base station are not limited to the above example. For example, the base station may include more components than the above-mentioned components or include fewer components than the above-mentioned components. Furthermore, the transceiver 2410, the base station controller 2420, and the storage unit 2430 may be implemented as a single chip.

The transceiver 2410, which refers to the base station's receiver and transmitter in a combined manner, may transmit/receive signals with another base station or other network devices. The transmitted/received signals may include control information and data. The transceiver 2410 may transmit system information to a UE, for example, and may transmit a synchronization signal or a reference signal. To this end, the transceiver 2410 may include an RF transmitter for up-converting the frequency of transmitted signals and amplifying the same, and a radio frequency (RF) receiver for low-noise-amplifying received signals and down-converting the frequency thereof. However, this is only an embodiment of the transceiver 2410, and the components of the transceiver 2410 are not limited to the RF transmitter and RF receiver. The transceiver 2410 may include a wired/wireless transceiver, and may include various components for transmitting/receiving signals. For example, the transceiver 2410 may receive signals through a communication channel (for example, radio channel) and output the same to the base station controller 2420, and may transmit signals output from the base station controller 2420 through the communication channel. In addition, the transceiver 2410 may receive communication signals and output the same to a processor, and may transmit signals output from the processor to another base station or another entity through a wired/wireless network.

The storage unit 2430 may store programs and data necessary for the base station's operations. The storage unit 2430 may also store control information or data included in signals acquired by the base station. The storage unit 2430 may include storage media, such as read only memory (ROM), random access memory (RAM), a hard disk, compact disc-ROM (CD-ROM), and a digital versatile disc (DVD), or a combination of storage media. The storage unit 2430 may at least one of information transmitted/received through the transceiver 2410 and information generated through the base station controller 2420.

In the disclosure, the base station controller 2420 may be defined as a circuit or an application-specific integrated circuit or at least one processor. The processor may include a communication processor (CP) configured to perform control for communication, and an application processor (AP) configured to control the upper layer, such as an application program. The base station controller 2420 may control overall operations of the base station according to an embodiment proposed in the disclosure. For example, the base station controller 2420 may control the flow of signals between respective blocks so as to perform operations according to the above-described flowcharts.

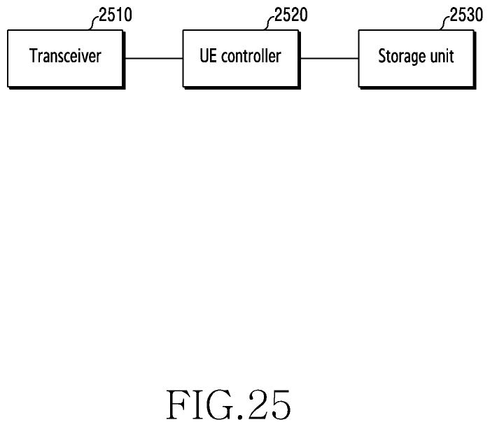

FIG. 25 illustrates a structure of a UE according to an embodiment of the disclosure.

Referring to FIG. 25, the UE may include a transceiver 2510, a UE controller 2520, and a storage unit 2530. The transceiver 2510, the UE controller 2520, and the storage unit 2530 may operate according to the above-described UE communication method. However, components of the UE are not limited to the above example. For example, the UE may include more components than the above-mentioned components or include fewer components than the above-mentioned components. Furthermore, the transceiver 2510, the UE controller 2520, and the storage unit 5430 may be implemented as a single chip.

The transceiver 2510, which refers to the UE's receiver and transmitter in a combined manner, may transmit/receive signals with the base station, another UE or other network devices. The signals transmitted/received with the base station may include control information and data. The transceiver 2510 may receive system information from the base station, for example, and may receive a synchronization signal or a reference signal. To this end, the transceiver 2510 may include an RF transmitter for up-converting the frequency of transmitted signals and amplifying the same, and an RF receiver for low-noise-amplifying received signals and down-converting the frequency thereof. However, this is only an embodiment of the transceiver 2510, and the components of the transceiver 5410 are not limited to the RF transmitter and RF receiver. The transceiver 2510 may also include a wired/wireless transceiver, and may include various components for transmitting/receiving signals. In addition, the transceiver 2510 may receive signals through a radio channel and output the same to the UE controller 2520, and may transmit signals output from the UE controller 2520 through the radio channel. In addition, the transceiver 2510 may receive communication signals and output the same to a processor, and may transmit signals output from the processor to a network entity through a wired/wireless network.

The storage unit 2530 may store programs and data necessary for the UE's operations. The storage unit 2530 may also store control information or data included in signals acquired by the UE. The storage unit 2530 may include storage media, such as ROM, RAM, a hard disk, a CD-ROM, and a DVD, or a combination of storage media.

In the disclosure, the UE controller 2520 may be defined as a circuit or an application-specific integrated circuit or at least one processor. The processor may include a communication processor (CP) configured to perform control for communication, and an application processor (AP) configured to control the upper layer, such as an application program. The UE controller 2520 may control overall operations of the UE according to an embodiment proposed in the disclosure. For example, the UE controller 2520 may control the flow of signals between respective blocks so as to perform operations according to the above-described flowcharts.

When implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including random access memory and flash memory, read only memory (ROM), electrically erasable programmable read only memory (EEPROM), a magnetic disc storage device, compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station of a wireless communication system, the method comprising:
generating a cell discontinuous transmission (DTX)/discontinuous reception (DRX) operation message comprising at least one field indicating an operation regarding at least one of a cell DTX operation and a cell DRX operation regarding each of at least one cell;
transmitting, to a user equipment (UE), the generated cell DTX/DRX operation message; and
performing communication with the UE in the at least one cell according to a cell DTX/DRX operation based on the transmitted cell DTX/DRX operation message.

2. The method of claim 1, wherein the at least one field comprises:
at least one bit indicating activation or deactivation of a cell DTX operation regarding each of the at least one cell; and
at least one bit indicating activation or deactivation of a cell DRX operation regarding each of the at least one cell.

3. The method of claim 1, wherein the at least one field comprises:
a bit indicating activation and deactivation of the cell DTX operation and the cell DRX operation regarding each of the at least one cell; or
one of the cell DTX operation or the cell DRX operation.

4. The method of claim 1, further comprising:
transmitting a radio resource control (RRC) message to the UE, the RRC message comprising at least one of configuration information regarding the cell DTX operation and configuration information regarding the cell DRX operation.

5. The method of claim 1, wherein the cell DTX/DRX operation message is a medium access control (MAC) control element (CE) or downlink control information (DCI).

6. The method of claim 1,
wherein the cell DTX operation is performed based on multiple pieces of DTX configuration information, and the cell DRX operation is performed based on multiple pieces of DRX configuration information, and
wherein the at least one field comprises a bit indicating at least one of the multiple pieces of DTX configuration information and the multiple pieces of DRX configuration information.

7. A method performed by a user equipment (UE) of a wireless communication system, the method comprising:
receiving, from a base station, a cell discontinuous transmission (DTX)/discontinuous reception (DRX) operation message corresponding to at least one cell, the cell DTX/DRX operation message comprising at least one field indicating at least one of a cell DTX operation and a cell DRX operation regarding each of the at least one cell; and
performing communication with the base station in the at least one cell according to a cell DTX/DRX operation based on the received cell DTX/DRX operation message.

8. The method of claim 7, wherein the at least one field comprises:
at least one bit indicating activation or deactivation of a cell DTX operation regarding each of the at least one cell; and
at least one bit indicating activation or deactivation of a cell DRX operation regarding each of the at least one cell.

9. The method of claim 7, wherein the at least one field comprises:
a bit indicating activation and deactivation of the cell DTX operation and the cell DRX operation regarding each of the at least one cell; or
one of the cell DTX operation or the cell DRX operation.

10. The method of claim 7,
wherein the cell DTX operation is performed based on multiple pieces of DTX configuration information,
wherein the cell DRX operation is performed based on multiple pieces of DRX configuration information, and
wherein the at least one field comprises a bit indicating at least one of the multiple pieces of DTX configuration information and the multiple pieces of DRX configuration information.

11. A base station of a wireless communication system, the base station comprising:
a transceiver; and
at least one processor coupled to the transceiver,
wherein the at least one processor is configured to:
generate a cell discontinuous transmission (DTX)/discontinuous reception (DRX) operation message comprising at least one field indicating an operation regarding at least one of a cell DTX operation and a cell DRX operation regarding each of at least one cell,
transmit, to a user equipment (UE), the generated cell DTX/DRX operation message, and
perform communication with the UE in the at least one cell according to a cell DTX/DRX operation based on the transmitted cell DTX/DRX operation message.

12. The base station of claim 11, wherein the at least one field comprises:
at least one bit indicating activation or deactivation of a cell DTX operation regarding each of the at least one cell; and
at least one bit indicating activation or deactivation of a cell DRX operation regarding each of the at least one cell.

13. The base station of claim 11, wherein the at least one field comprises:
a bit indicating activation and deactivation of the cell DTX operation and the cell DRX operation regarding each of the at least one cell; or
one of the cell DTX operation or the cell DRX operation.

14. The base station of claim 11, wherein the at least one processor is configured to transmit a radio resource control (RRC) message to the UE, the RRC message comprising at least one of configuration information regarding the cell DTX operation and configuration information regarding the cell DRX operation.

15. The base station of claim 11, wherein the cell DTX/DRX operation message is a medium access control (MAC) control element (CE) or downlink control information (DCI).

16. The base station of claim 11,
wherein the cell DTX operation is performed based on multiple pieces of DTX configuration information, and the cell DRX operation is performed based on multiple pieces of DRX configuration information, and
wherein the at least one field comprises a bit indicating at least one of the multiple pieces of DTX configuration information and the multiple pieces of DRX configuration information.

17. A user equipment (UE) of a wireless communication system, the UE comprising:
a transceiver; and
at least one processor coupled to the transceiver,
wherein the at least one processor is configured to:
receive, from a base station, a cell discontinuous transmission (DTX)/discontinuous reception (DRX) operation message corresponding to at least one cell, the cell DTX/DRX operation message comprising at least one field indicating at least one of a cell DTX operation and a cell DRX operation regarding each of the at least one cell, and
perform communication with the base station in the at least one cell according to a cell DTX/DRX operation based on the received cell DTX/DRX operation message.

18. The UE of claim 17, wherein the at least one field comprises:
at least one bit indicating activation or deactivation of a cell DTX operation regarding each of the at least one cell; and
at least one bit indicating activation or deactivation of a cell DRX operation regarding each of the at least one cell.

19. The UE of claim 17, wherein the at least one field comprises:
a bit indicating activation and deactivation of the cell DTX operation and the cell DRX operation regarding each of the at least one cell; or
one of the cell DTX operation or the cell DRX operation.

20. The UE of claim 17,
wherein the cell DTX operation is performed based on multiple pieces of DTX configuration information, and the cell DRX operation is performed based on multiple pieces of DRX configuration information, and
wherein the at least one field comprises a bit indicating at least one of the multiple pieces of DTX configuration information and the multiple pieces of DRX configuration information.
